(19) United States
(12) Patent Application Publication
(10) Pub. No.: US 2003/0055529 A1
(43) Pub. Date: Mar. 20, 2003

(54) System for automatically changing computer system configuration

(75) Inventor: Takashi Aosawa, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/235,710

(22) Filed: Sep. 6, 2002

(30) Foreign Application Priority Data
Sep. 14, 2001 (JP) 2001-279000

(51) Int. Cl. G06F 7/00; G06F 15/173

(52) U.S. Cl. 700/220; 709/223

(57) ABSTRACT

In a computer system configuration changing system for improving the simplicity and flexibility in changing the computer system configuration to relieve the work load of an operator taking charge of changing the configuration, there are provided a configuration changing unit which receives a command for changing the configuration, that allows for incomplete/partial contents, from an operator in charge of changing the configuration, and then delivers the configuration information represented by a configuration changing command to a configuration determining unit, and the configuration determining unit which refers to a computer system configuration information database and to a component-to-component interdependency rule database to complement or render perfect the incomplete/partial configuration information received from the configuration changing unit, while referring to a component selection guideline database and to a component attribute database to cope properly and flexibly with a selection guideline to build up a computer system, and which may find the computer configuration determining information to notify the configuration changing device of the computer configuration determining information.

### FIELD OF THE INVENTION

This invention relates to an automated configuration changing system of a computer system in which the operation of combining components making up a computer system (capable of controlling the configuration change by a configuration changing device), in order to determine the configuration, i.e., a set of functional components (components for achieving various computer hardware functions) of a computer, may be carried out automatically.

The ‘components’ referred to above may be exemplified by a CPU (Central Processing ) board, a memory board, an input/output control device and an external storage device.

The configuration changing device is a device equipped with a function of constituting a computer by optionally combining various components. Depending on the manner of combining the components, plural types of computers can be constituted in one computer system.

### BACKGROUND OF THE INVENTION

Up to now, such a computer system, capable of constituting a computer by optionally combining different components, has been proposed and implemented. It should be noted that, as the scale of the computer system is enlarged, the volume of the information required in constituting a computer as well as the labor involved in constituting the computer tends to be increased.

Under such situation, it has been proposed in a conventional technique (for example, Japanese Patent Kokai Publication JP-04-047356) a ‘Computer System Configuration Changing Device’, having a function-to-function interdependency rule unit for realizing a flexible computer configuration and for reducing the labor in constructing the configuration.

It should be noted that the recent computer hardware is flexibly designed, as a result of which the relationship of component-to-component interdependency is diminishing. If the relationship of component-to-component interdependency persists, computer system configurations can be automatically determined, if only to a certain extent, by the computer system configuration changing device having a system for such function-to-function interdependency rule. However, the lower such interdependency relationship among computer hardware functional components, the smaller becomes the fraction of the configurations that can be automatically determined, thus increasing the labor involved in changing the configuration.

### SUMMARY OF THE DISCLOSURE

The above-mentioned conventional technique (computer system configuration changing device) has had a drawback that, the smaller the fraction of the computer hardware functional components having a function-to-function interdependency relationship, the smaller becomes the automatically determined fraction of the configuration, thus increasing the labor involved in changing the configuration.

In view of the above-depicted status of the art, it is an object of the present invention to provide a system for automatically changing a computer system configuration in which the above-mentioned problems may be alleviated, and in which, even if the computer system is of a large scale and the hardware configuration is flexibly designed, simplicity or flexibility in decision of the computer configuration (change in the configuration of the computer system) may be maintained to relieve the work load for an operator responsible for changing the computer system configuration (personnel who commands the change in the computer configuration).

Another object of the present invention is to diversify the usage of a computer in a computer system by judicious combination of malfunction detection means.

As a patent gazette for the conventional technique pertinent to the system for automatically changing the computer system configuration such as is proposed by the present invention, there are, in addition to the aforementioned patent gazette, the ‘Japanese Patent Kokai Publication JP-2000-148814’ and the ‘Japanese Patent Kokai Publication JP-2000-263895’, which are analogous to the present invention in that these patent gazettes scrutinize the technique of ‘changing the configuration’ in some sense or other.

The technique described in the Japanese Patent Kokai Publication JP-2000-148814, entitled ‘Component Data Management System and Computer-Readable Recording Medium Having Stored the Component Data Management Program’, is aimed to provide a component data management system which enables a component configuration of a product in a production designing branch to be changed easily and accurately, and is intrinsically different from the present invention which ‘improves simplicity or flexibility in deciding on the component configuration of a product in the production designing branch to enable the work load on an operator responsible for the computer system configuration to be relieved’.

The technique described in the aforementioned Japanese Patent Kokai Publication JP-2000-263895 (Picture Output Controlling Apparatus, Status Outputting Method of Picture Output Controlling Apparatus and Recording medium Having Stored the Computer-Readable Program) is designed to adequately control the picture output of the system configuration information in such a manner as to cope with changes in the system configuration in a picture output controlling apparatus, and intrinsically differs from the present invention which ‘improves simplicity or flexibility in deciding on a change in a computer system configuration to enable the work load on an operator responsible for the computer system configuration to be relieved’.

The above and other objects of the invention are attained in accordance with one aspect on the present invention by providing a system for automatically changing a computer system configuration comprising a configuration management device making a request for changing the configuration of a computer system to a configuration changing device(by notifying the determined configuration information of the computer system), which is a device enabling the computer system configuration to be changed. The configuration management device comprises configuration changing means for receiving a configuration changing command, allowing for incomplete/partial contents, from an operator in charge of changing the configuration, and for delivering the configuration information represented by the configuration changing command to the configuration determining means, and the configuration determining means. The configuration determining means refers to a computer system configuration information database and to a component-to-component interdependency rule database to complement or render perfect the incomplete/partial configuration information received from the configuration changing means. The configuration determining means also refers to a component selection guideline database and to a component attribute database to deal properly and flexibly with a selection guideline to build up a computer system. As a result, the configuration determining means finds the computer configuration determining information to notify the configuration-changing device of the computer configuration determining information.

In a system for automatically changing a computer system configuration, in accordance with another aspect of the present invention, there is also provided a configuration management device making a request for changing the configuration of a computer system to a configuration changing device, as a device enabling the computer system configuration to be changed, comprising configuration changing commanding means for giving a command (notification) to configuration changing means to build up a desired computer in a computer system, the configuration of which is to be changed, at a desired timing, based on preset scheduling information, a computer system configuration information database, as a database having stored the information concerning the configuration of the desired computer, and also having stored in advance one or more of the configuration information including the contents of the ‘configuration changing command (in which imperfect/partial contents are allowed) from the operator in charge of changing the configuration’ as defined in claim 1, configuration changing means for reading out, from the computer system configuration information database, the configuration information for a computer specified by the command from the configuration changing command means, based on the command, and for notifying the configuration information to configuration determining means, and the configuration determining means for referring to a computer system configuration information database and to a component-to-component interdependency rule database to complement or render perfect the incomplete/partial configuration information received from the configuration changing means, and for referring to a component selection guideline database or to a component attribute database to deal properly and flexibly with a selection guideline to build up a computer system. As a result, the configuration determining finds the computer configuration determining information to notify the configuration-changing device of the computer configuration determining information.

In a system for automatically changing a computer system configuration, in accordance with a further aspect of the present invention, there is also provided a configuration management device making a request for changing the configuration of a computer system to a configuration changing device, as a device enabling the computer system configuration to be changed, comprising a computer system configuration information database having stored the information concerning the configuration of a desired computer, and also having stored, as the configuration information, the information indicating the contents of a configuration changing command from an operator responsible for changing the configuration, and also indicating whether or not a computer corresponding to the command for changing the configuration has already been constituted, malfunction detection means for monitoring a computer system, the configuration of which is to be changed, detecting occurrence of a malfunction, locating a malfunctioning component, changing the contents of the computer system configuration information database in such a manner as to delete the information indicating the malfunctioning component, and for sending a command for changing the configuration of the computer system as a result of occurrence of a malfunction in case the malfunctioning component is being used as a computer component on malfunction occurrence, the configuration changing means for causing, on receipt of each configuration changing command from an operator responsible for changing the configuration allowing for incomplete/partial content, the configuration information indicating the contents of each configuration changing command to be stored in the computer system configuration information database, for subsequently notifying the configuration determining means of each configuration information, initializing the computer system configuration information database based on a command from the malfunction detection means, for reading out from the computer system configuration information database the configuration information having set therein the information indicating that the computer has already been constituted, and for notifying the configuration determining means of the configuration information, and the configuration determining means for referring to a computer system configuration information database and to a component-to-component interdependency rule database to complement or render perfect the incomplete/partial configuration information received from the configuration changing means, the configuration determining means also referring to a component selection guideline database and to a component attribute database to deal properly and flexibly with a selection guideline to build up a computer system. The configuration determining means resultantly finds the computer configuration determining information to notify the configuration-changing device of the computer configuration determining information.

In a system for automatically changing a computer system configuration, in accordance with a further aspect of the present invention, there is provided a configuration management device for making a request for changing the configuration to a configuration change device enabling the configuration of a computer system to be changed, comprising configuration changing command means for giving a command to configuration changing means in order to constitute a desired computer in a computer system, the configuration of which is to be changed, at a desired timing, based on the preset schedule information, a computer system configuration information database, as a database having stored the information concerning the configuration of a desired computer, and also having stored in advance one or more of the configuration information of the same contents as the contents of the ‘configuration changing command from the operator in charge of changing the configuration’ as defined in claim 1, malfunction detection means for monitoring a computer system, the configuration of which is to be changed, detecting the occurrence of a malfunction, locating a malfunctioning component, changing the contents of the computer system configuration information database in such a manner as to delete the information indicating the malfunctioning component, sending a command for changing the configuration of the computer system as a result of occurrence of a malfunction in case the malfunctioning component is being used as a computer component on malfunction occurrence, the configuration changing means for reading out, based on a command from the configuration changing command means, the configuration information for a computer, specified by the command, from the computer system configuration information database, for initializing the computer system configuration information database, based on a command from the malfunction detection means, and for reading out from the computer system configuration information database the information indicating that the computer has already been constituted, to notify the configuration determining means of the configuration information, the configuration determining means for referring to a computer system configuration information database and to a component-to-component interdependency rule database to complement or render perfect the incomplete/partial configuration information received from the configuration changing means, and also referring to a component selection guideline database and to a component attribute database to deal properly flexibly with a selection guideline to build up a computer system. As a result, the configuration determining means finds the computer configuration determining information to notify the configuration-changing device of the computer configuration determining information.

In a system for automatically changing a computer system configuration in accordance with the present invention, the configuration determining means preferably includes necessary component selection means for referring to the computer system configuration information database, for complementing components that are in shortage to constitute the computer along with the components as specified by the configuration information received from the configuration changing means and for storing the complemented configuration information on a required component work memory, component selection means for selecting the components one by one from the required component work memory, having the information stored therein by the necessary component selection means, and for deleting the so selected components, until the required component work memory is empty, the component selection means for referring to the computer system configuration information database to list up only those components which are the selected components corresponding to the ‘components not used as computer components’ and the information of which is not present in a determined component storage memory, guideline contemplating means for referring to a component selection guideline database for retrieving the guideline for the component type of the components listed up by the component selection means and for adding to a determined component storage memory the information of components selected from the components consistent with a guideline if such guideline has been found, dependent component extraction means for referring to a component-to-component interdependency rule database to retrieve components dependent on the components as selected by the guideline contemplating means and for adding to the determined component storage memory the information of the dependent components if there are such dependent components, and configuration change notification means for requesting a configuration changing device to constitute a computer having as constituent components the components the information of which has been stored in the determined component storage memory in case the component selection means has found that the ‘required component work memory is empty’, the configuration change notification means verifying whether or not the requested configuration change has met success to update the computer system configuration information database based on the verification result.

Still other objects and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a block diagram showing the configuration of the automatic computer system configuration changing system according to a first embodiment of the present invention.

FIG. 2 is a block diagram showing the detailed configuration of the configuration determining means shown in FIG. 1.

FIG. 3 is a flow diagram showing the processing of the necessary component selection means shown in FIG. 2.

FIG. 4 is a flow diagram showing the processing by the component selection means shown in FIG. 2.

FIG. 5 is a flow diagram showing the processing of the guideline contemplating means in FIG. 2.

FIG. 6 is a flow diagram showing the processing of dependent component extracting means shown in FIG. 2.

FIG. 7 is a flow diagram showing the processing in configuration change notification means.

FIG. 8 is a block diagram showing an instance of a specified configuration of the computer system shown in FIG. 1.

FIG. 9 shows a specified instance of the contents of the computer system configuration information database shown in FIG. 1 (instance corresponding to the configuration of the computer system shown in FIG. 8).

FIG. 10 shows a specified instance of the contents of the component-to-component interdependency rule database (instance corresponding toe the configuration of the computer system shown in FIG. 8).

FIG. 11 shows a specified instance of the contents of the component selection guideline database (instance corresponding to the configuration of the computer system shown in FIG. 8).

FIG. 12 shows a specified instance of the contents of the component attribute database (instance corresponding to the configuration of the computer system shown in FIG. 8).

FIG. 13 is a block diagram showing the configuration of an automatic computer system configuration changing system according to a second embodiment of the present invention.

FIG. 14 shows a specified instance of the contents of the computer system configuration information database shown in FIG. 13.

FIG. 15 is a block diagram showing the configuration of an automatic computer system configuration changing system according to a third embodiment of the present invention.

FIG. 16 is a flow diagram showing the processing by the malfunction detecting means shown in FIG. 15.

FIG. 17 is a flow diagram showing the processing by the configuration changing means shown in FIG. 15.

FIG. 18 shows a specified instance of the contents of the computer system configuration information database shown in FIG. 15.

FIG. 19 shows a specified instance of the contents of the computer system configuration information database shown in FIG. 18.

FIG. 20 is a block diagram showing the configuration of the automatic computer system configuration changing system according to a fourth embodiment of the present invention.

FIG. 21 shows a specified instance of the contents of the computer system configuration information database shown in FIG. 15 (computer system configuration information database with a ‘required number’ added thereto).

FIG. 22 is a flow diagram showing the processing by the configuration changing means of FIG. 15 (configuration changing means in the modification of the computer system configuration information database with the ‘required number’ added thereto).

FIG. 23 is a block diagram showing the configuration of the automatic computer system configuration changing system according to a fifth embodiment of the present invention.

FIG. 24 is a block diagram showing the configuration of the automatic computer system configuration changing system according to a sixth embodiment of the present invention.

FIG. 25 is a block diagram showing the configuration of the automatic computer system configuration changing system according to a seventh embodiment of the present invention.

FIG. 26 is a block diagram showing the configuration of the automatic computer system configuration changing system according to an eighth embodiment of the present invention.

### PREFERRED EMBODIMENT OF THE INVENTION

Referring to the drawings preferred embodiments of the present invention is now explained in detail.

(1) A First Embodiment

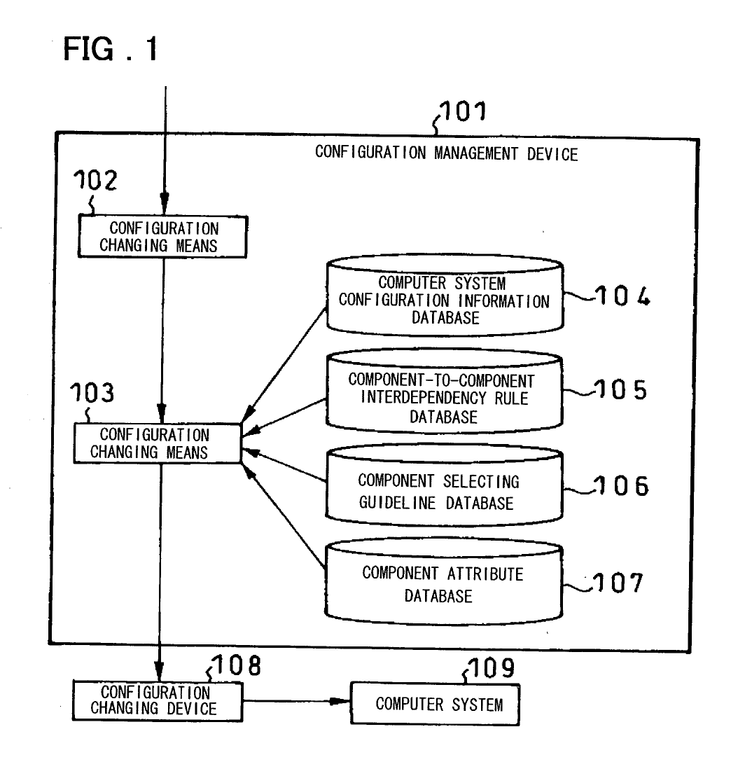

FIG. 1 is a block diagram showing the structure of a system for automatically changing the computer system configuration according to a first embodiment of the present invention.

Referring to FIG. 1, the system for automatically changing the computer system configuration according to the embodiment of the present invention is made up by a configuration management device 101, which is a device for implementing the system for automatically changing the computer system configuration, a configuration changing device 108, which allows to control the changing of the configuration of a computer system 109, and the computer system 109, the configuration of which is to be changed.

The configuration management device 101 is connected to the configuration changing device 108 by for example a communication path, and commands (requests) the configuration changing device 108 to change the configuration of the computer system 109.

Responsive to the request (command) from the configuration management device 101, and based on its command, the configuration changing device 108 proceeds to change the configuration of the computer system 109 (make the setting or change the configuration of a computer in the computer system 109).

There are occasions where the configuration-changing device 108 is included in the computer system 109 or controls plural computer systems including the computer system 109.

The configuration management device 101 includes configuration changing means 102, configuration determining means 103, a computer system configuration information database 104, a component-to-component interdependency rule database 105, a component selecting guideline database 106 and a component attribute database 107.

The configuration changing means 102 acquires a configuration changing command, issued by an operator responsible for change of the computer system configuration (personnel who commands the change in the computer configuration) to the configuration management device 101, to transmit the configuration changing command to the configuration determining means 103.

That is, the ‘computer configuration information desired by the configuration changing commander’ may be sent by a configuration changing command via configuration changing means 102 to the configuration determining means 103. The configuration information need not be the strict configuration information to establish the computer and may also be the configuration information specifying only a portion of the component type information making up the computer (incomplete or partial configuration information), such as ‘a computer having two sets of external storage devices’ or ‘a computer having a set of a CPU board’.

The configuration determining means 103 has the function of determining computer components from the configuration information obtained from the configuration changing means 102 (the configuration information indicated by the configuration changing command).

The computer system configuration information database 104 holds (stores) the information indicating the types of the necessary minimum components for the establishment as a computer and the information indicating the state of use of respective components. The configuration determining means 103 refers to this computer system configuration information database 104 to check whether or not there have been provided all the components for establishment as a computer.

The component-to-component interdependency rule database 105 holds the information pertinent to the relationship of interdependency among computer components making up a computer. If a component has been unequivocally determined from the configuration changing command (configuration information) obtained from the configuration changing means 102, the configuration determining means 103 refers to this computer system configuration information database 104 to determine a component dependent on the so uniquely determined component as being a component to be assembled into the computer.

The component selecting guideline database 106 holds the guideline (such as a guideline concerning the performance) in selecting the components making up the computer.

The component attribute database 107 holds the information indicating the attributes of the components making up the computer.

When the configuration determining means 103 selects the component, there may be plural components satisfying the commanded conditions. For example, if the constituent information indicated by the configuration changing command from the configuration changing means 102 is ‘a computer having two sets of the external storage devices’ and in actuality the computer system 109 has three sets of the external storage devices, there are three combinations of the external storage devices which satisfy the condition of ‘having two sets of the external storage devices’, so that the component configuration cannot be determined unequivocally. In such case, the configuration determining means 103 refers to the aforementioned component selecting guideline database 106 and to the component attribute database 107 to select the most ideal components. For example, assume that the component selecting guideline database 106 is holding the guideline that ‘as the external storage device, a storage device having as large a capacity as possible is used’ and that the capacity values of the totality of the eternal storage devices owned by the computer system 109 have been stored in the component attribute database 107 as the attributes of the external storage device. In such case, the configuration determining means 103 selects, responsive to the request for ‘a computer having two sets of the external storage devices’, upper two sets of the external storage devices of larger capacity values among the external storage devices owned by the computer system 109. As from that time, the configuration determining means refers to the computer system configuration information database 104 and the component-to-component interdependency rule database 105 to further determine the computer configuration.

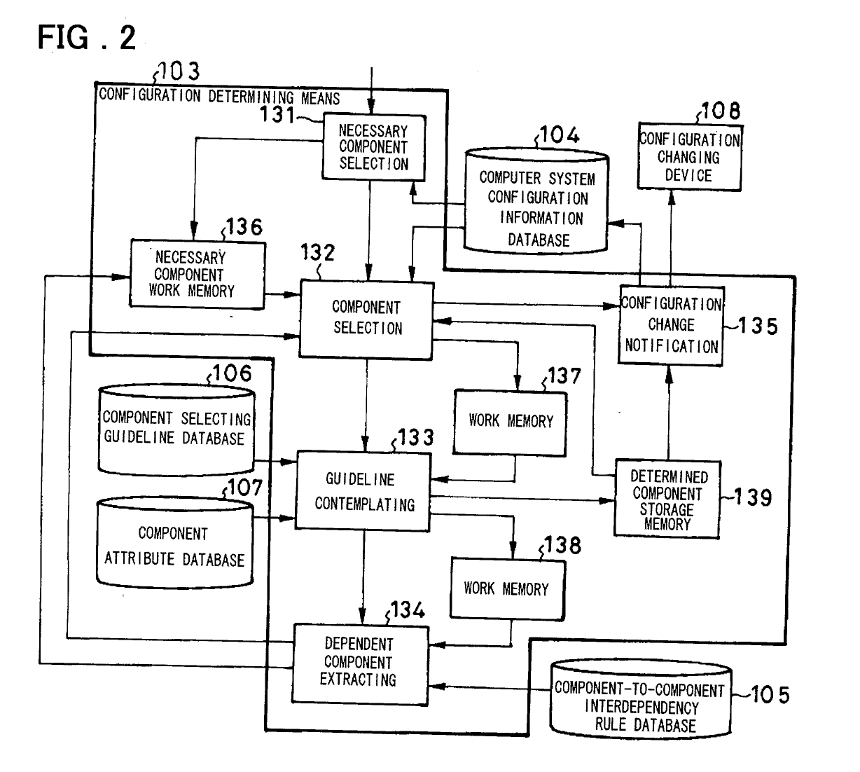

FIG. 2 is a block diagram showing a detailed structure of the configuration determining means 103 shown in FIG. 1.

Referring to FIG. 2, the configuration determining means 103 is made up by necessary component selection means 131, component selection means 132, guideline contemplating means 133, dependent component extracting means 134, configuration change notification means 135, and a set of memories used for exchanging the information among those respective means (necessary component work memory 136, a work memory 137, a work memory 138 and a determined component storage memory 139).

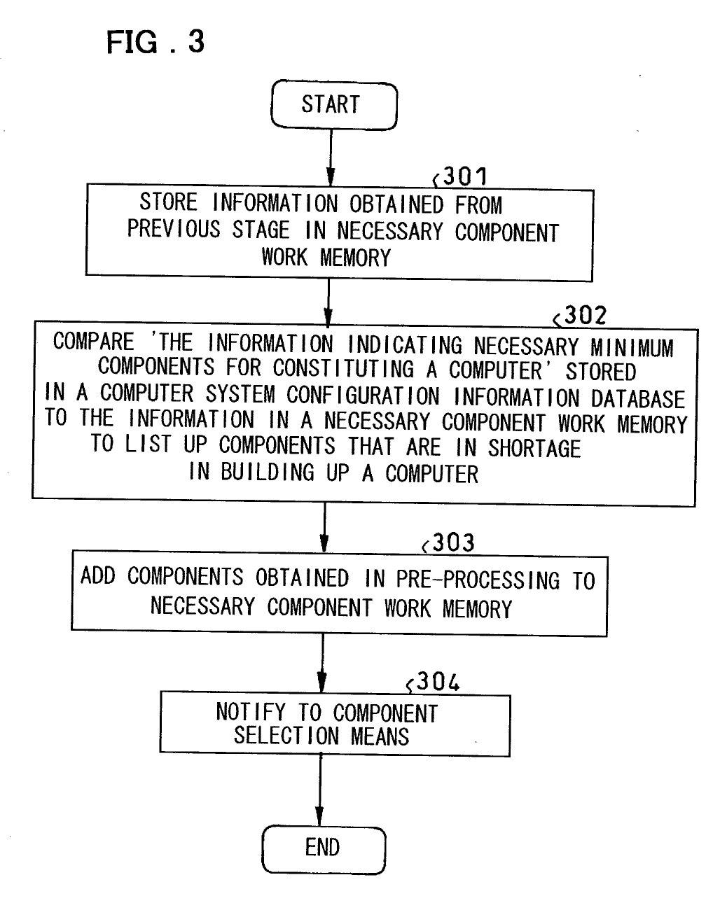

FIG. 3 shows a flow diagram illustrating the processing by the necessary component selection means 131. This processing is made up by a step 301 for storing the information in a necessary component work memory, a step 302 for listing up lacking components, a step 303 for adding the information to the necessary component work memory and a step 304 for notification to component selection means.

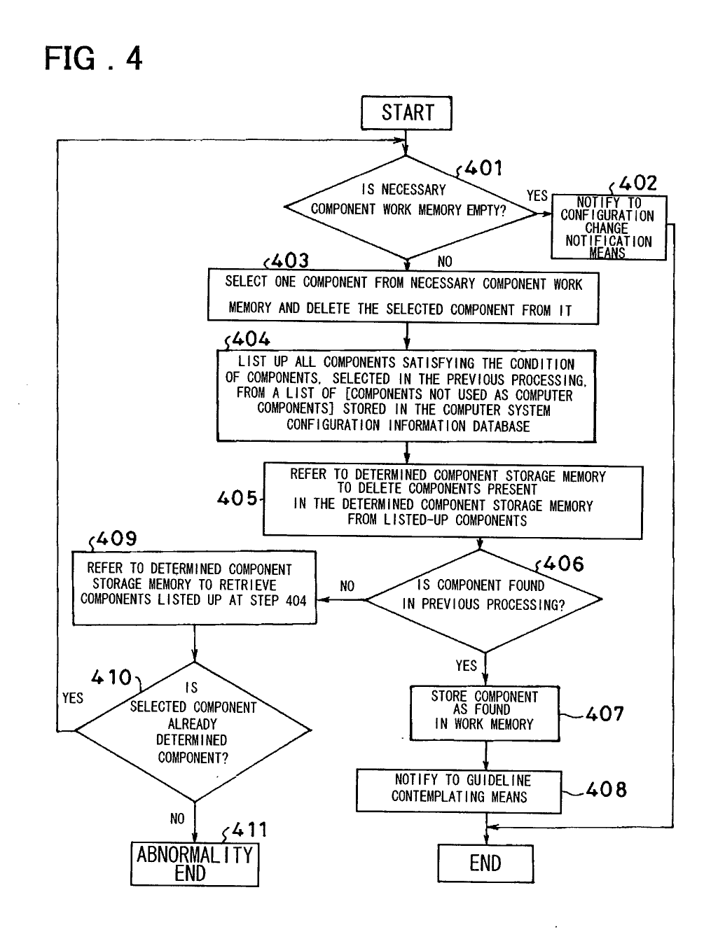

FIG. 4 shows a flow diagram illustrating the processing by the component selection means 132. This processing is made up by a step 401 for verifying whether or not the necessary component work memory is empty, a step 402 for notification to the configuration change notification means, a step 403 for selecting and deleting the components, a step 404 of listing up the totality of components meeting the conditions, a step 405 for deleting components present in a determined component storage memory, a component detection decision step 406, a step 407 for storage in a detected component storage memory, a step 408 for notification to guideline contemplating means, a step 409 for searching for list-up components, a step 410 for giving decision as to relevance of already determined components, and a step 411 for abnormal termination.

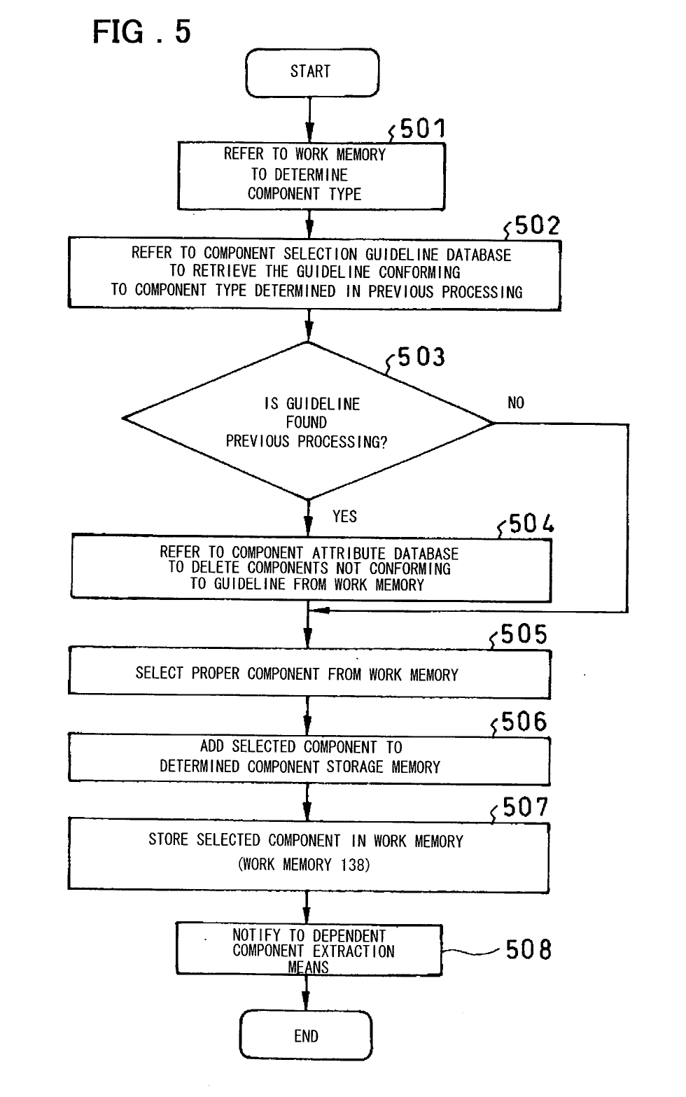

FIG. 5 shows the processing by the guideline contemplating means 133. This processing is made up by a step 501 for deciding on the component type, a step 502 for retrieving the guideline for coping with the determined component type, a step 503 for detecting and giving decision as to the guideline, a step 504 for deleting components not consistent with the guideline, a step 505 for selecting components, a step 506 for adding a selected component to a determined component storage memory, a step 507 for storing a selected component in a work memory, and a step 508 for notification to dependent component extraction means

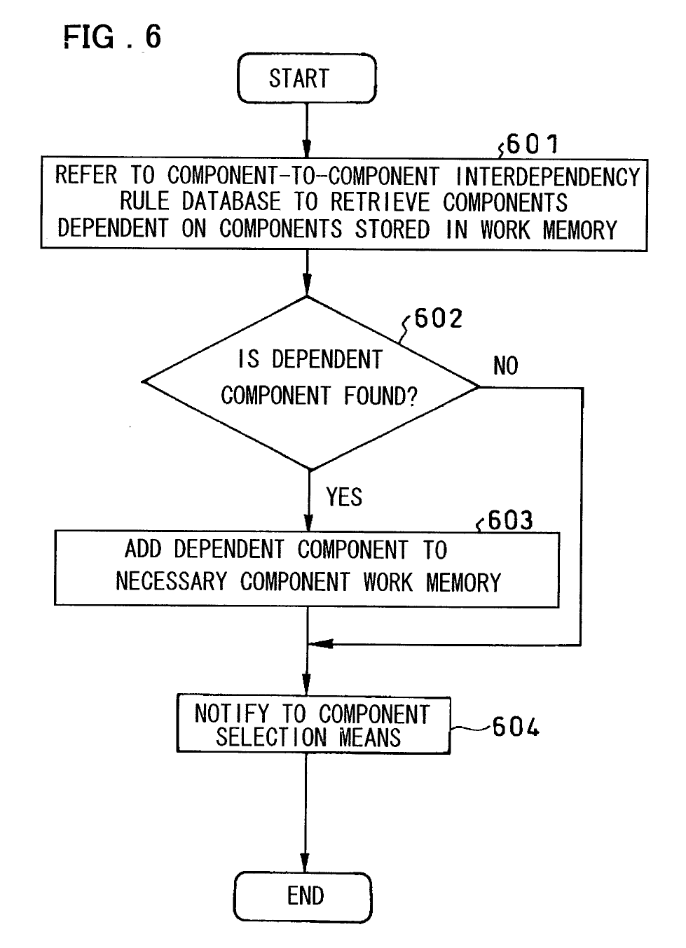

FIG. 6 illustrates the processing of the dependent component extracting means 134. This processing is made up by a step 601 for retrieving a dependent component, a step 602 for checking a detection of a dependent component, a step 603 for adding a dependent component, and a step 604 for notification to component selection means.

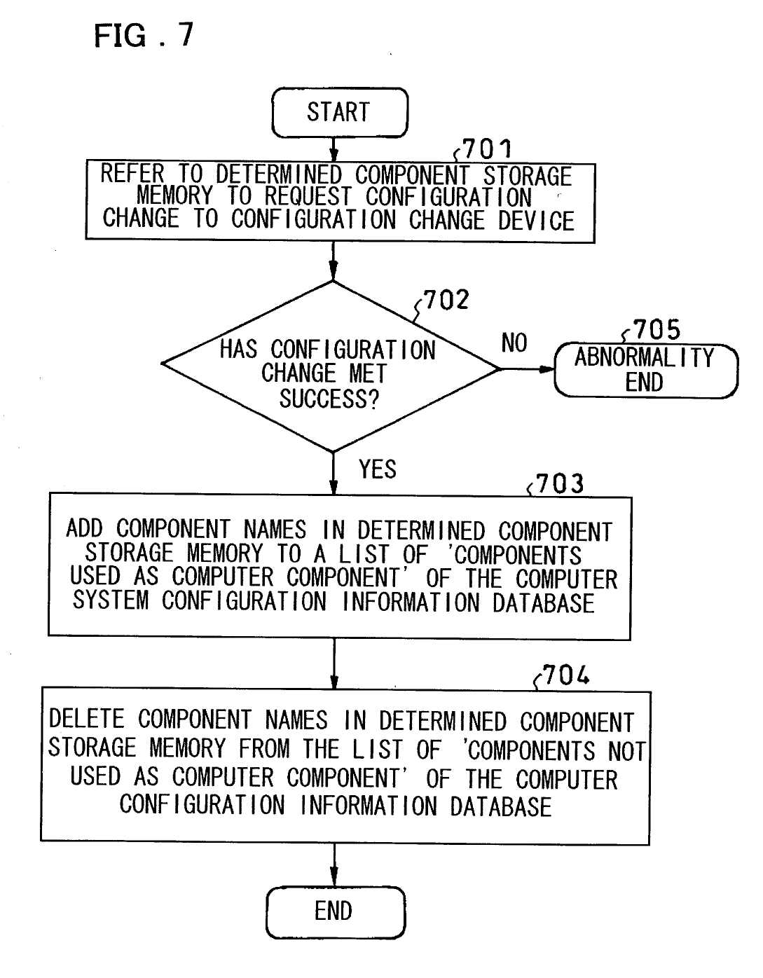

FIG. 7 shows a flow diagram illustrating the processing of the configuration change notification means 135. This processing is made up by a step 701 for requesting a configuration change, a step for deciding success/failure of the configuration change, a step 703 for adding computer system configuration information database component names, a step 704 for deleting the computer system configuration information database component names, and a step 705 for terminating by an occurrence of abnormality.

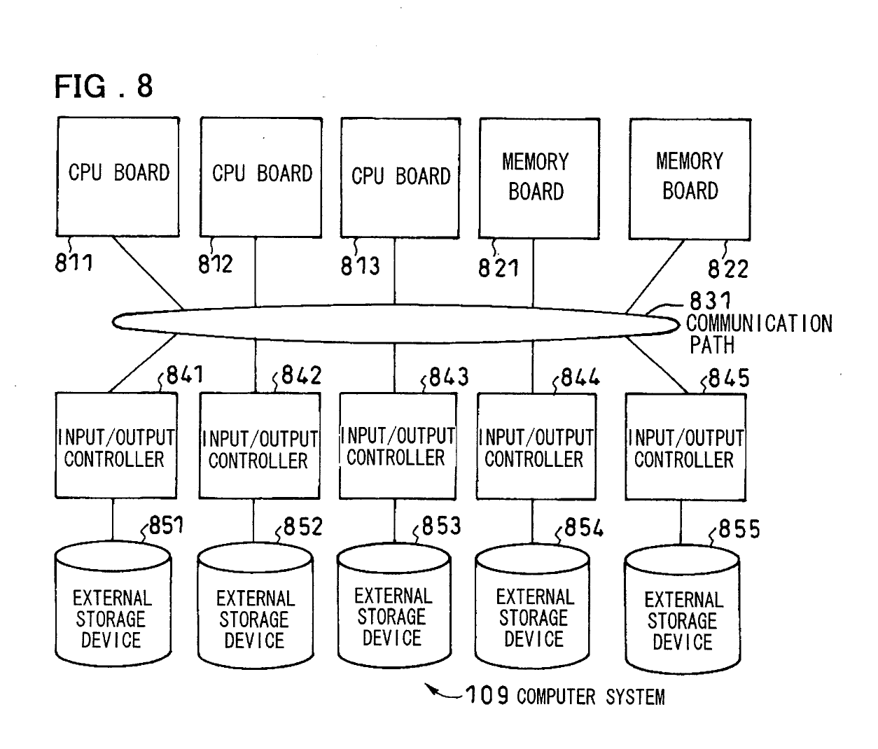

FIG. 8 is a block diagram illustrating an exemplary structure of the computer system 109 shown in FIG. 1.

A specified structure of the computer system 109 shown in FIG. 8 is made up by three CPU boards 811 to 813, two memory boards 821 and 822, and five input/output controllers 841 to 845, interconnected over a communication path 831. To the input/output controllers 841 to 845 are connected external storage devices 851 to 855, respectively.

The configuration-changing device 108 is able to freely change the structure of this computer system 109 by changing the Connection State of the communication path 831. For example, the CPU board 811, memory board 821 and the input/output controller 841 may be interconnected over the communication path 831 to constitute a computer. (The external storage device 851 also becomes a component through the input/output controller 841).

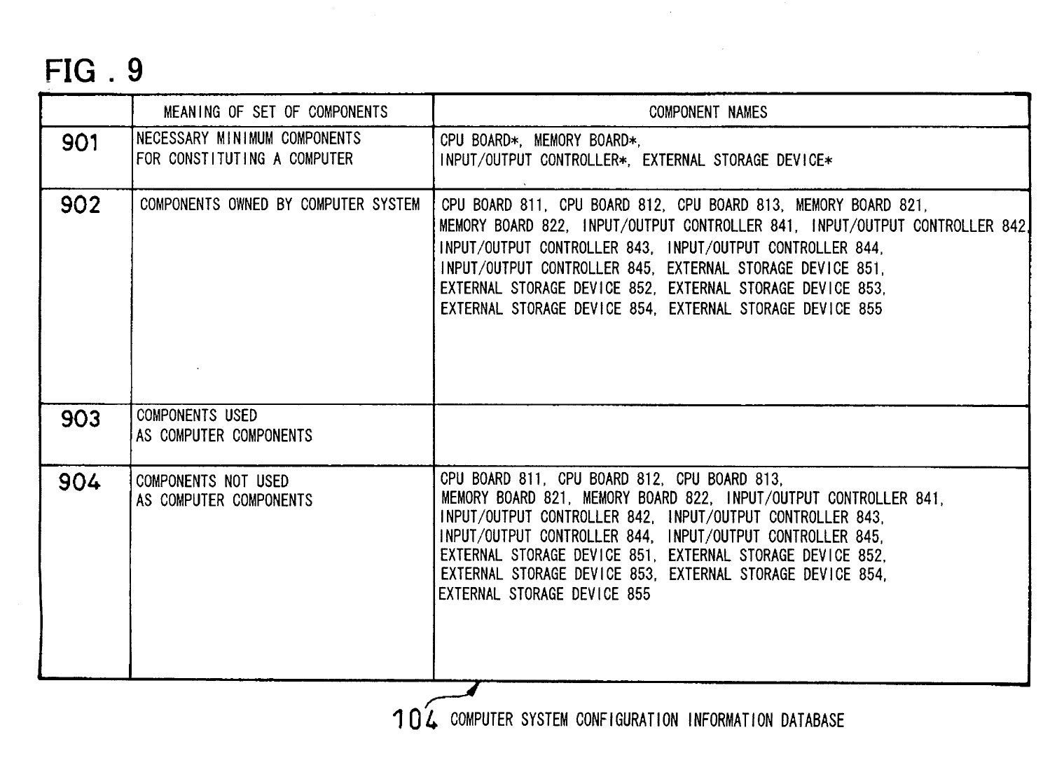

FIG. 9 shows a specified instance of the contents of the computer system configuration information database 104 (an instance corresponding to the structure of the computer system 109 shown in FIG. 8). In each row of the computer system configuration information database 104, there exist the information of ‘meaning set of components’(‘necessary minimum components for constituting a computer’), ‘components owned by the computer system’, ‘components used as computer components’ or ‘components not used as computer component’ and ‘component names’.

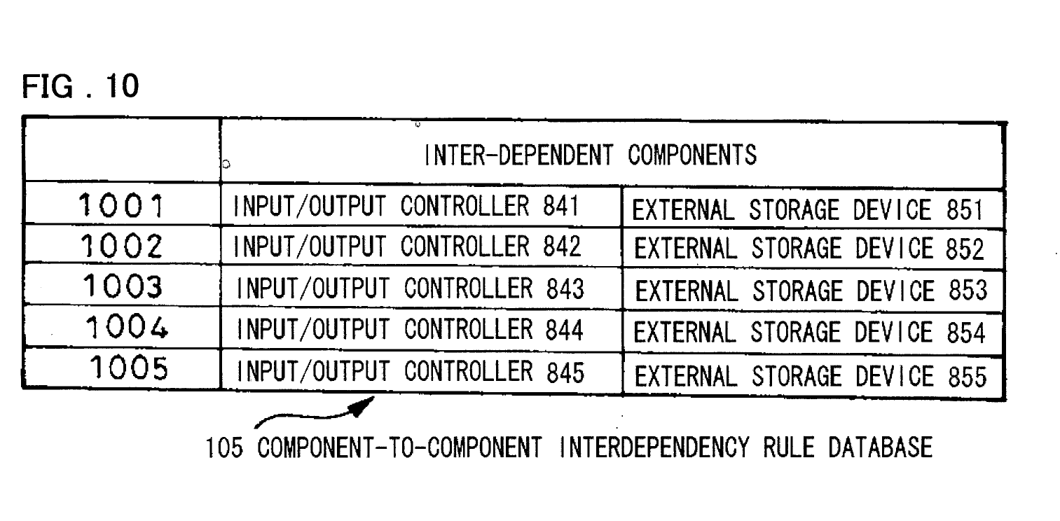

The information described in the below is stored in the computer system configuration information database 104 shown in FIG. 9. It should be noted that the row numbers 901 to 904 are for illustration sake only and are not by way of limitation, as do the row numbers entered in FIG. 10 ff. showing specified examples of the database.

In the row 901 are stored component names of the necessary minimum components making up a computer. The symbol * annexed to the ends of the component names indicate that the component name in question denotes the component type. This holds in the following description where the symbol * is used without corresponding explanation. As an example, the row 901 indicates that ‘for constituting a computer, the CPU board, memory board, input/output controller and the external storage device are required as the minimum requirement’. Since these components are all given as the types of the components (refer to the meaning of the asterisk * above), the above example of the row also indicates that ‘it does not matter which specified structure a component in question has, provided that the requirement for the component type is met (for example, it does not matter whether the memory board is the memory board 821 or the memory board 822)’.

In the row 902, the names of the totality of the components owned by the computer system 109 shown in FIG. 8 are stored.

In the row 903 are stored the names of the components making up a computer, already constituted on the computer system 109 of FIG. 9, that is the components used for constituting the computer. Since there are no component parts stored in the row 903, it is seen that no computer has for the present been constituted in the computer system 109.

In the row 904 are stored the names of the components usable in newly constituting a computer. Since no computer has as yet been constituted in the computer system 109, the names of the totality of the components shown in FIG. 8 are stored.

FIG. 10 shows a specified instance of the contents of the component-to-component interdependency rule database 105, shown in FIG. 1 (an instance associated with the structure of the computer system 109 shown in FIG. 8). In each row of this structure of the component-to-component interdependency rule database 105, there is the information of the ‘inter-dependent components’. That is, in this component-to-component interdependency rule database 105, there is stored the information representing the relationship of inter-dependence among different components in the computer system 109 shown in FIG. 8.

In the row 1001, for example, there is stored the information: ‘If the input/output controller 841 is used, since the external storage device 851 is physically connected to the input/output control device 841, the external storage device 851 compulsorily becomes a component of the computer, without regard to the intention on the part of the configuration changing commanding personnel (for example, a supervisor of the computer system 109) of using or not using the external storage device 851’.

If the reverse relationship of inter-dependence is considered, it is seen that, in view of the state of physical interconnection, if the external storage device 851 is used, the input/output control device 841 becomes necessary as a component.

In this manner, the component-to-component interdependency rule database 105 is holding the information concerning the physical interconnection among different components, this information being used as constraint conditions when the components making up the computer are selected automatically.

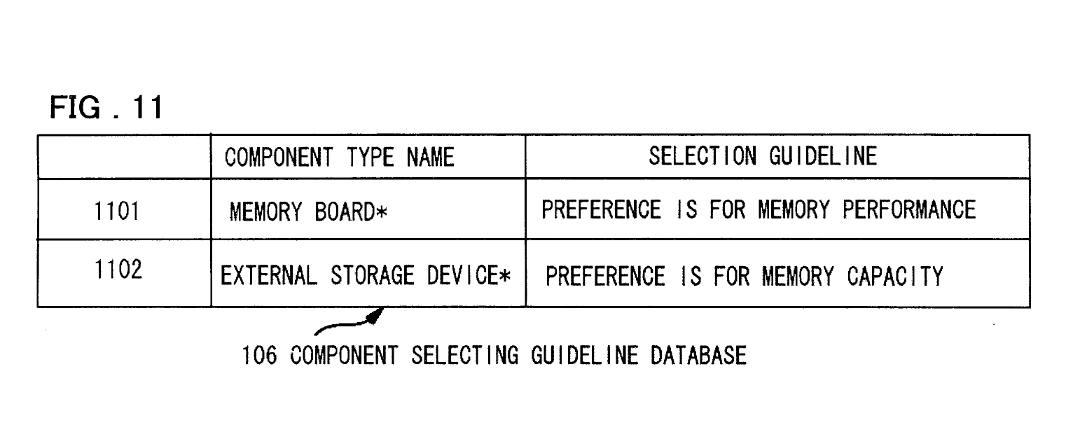

FIG. 11 shows a specified example of the contents of the component selecting guideline database 106 (an instance associated with the structure of the computer system 109 shown in FIG. 8). In each row of the component selecting guideline database 106, there is the information ‘component type names’ and ‘selection guideline’. That is, the component selecting guideline database 106 holds the information indicating the guideline in selecting the components making up the computer in the computer system 109 shown in FIG. 8.

In a row 1101, for example, there is stored the guideline: ‘If a memory board is used as a computer component, a memory board having higher memory performance is preferentially used’.

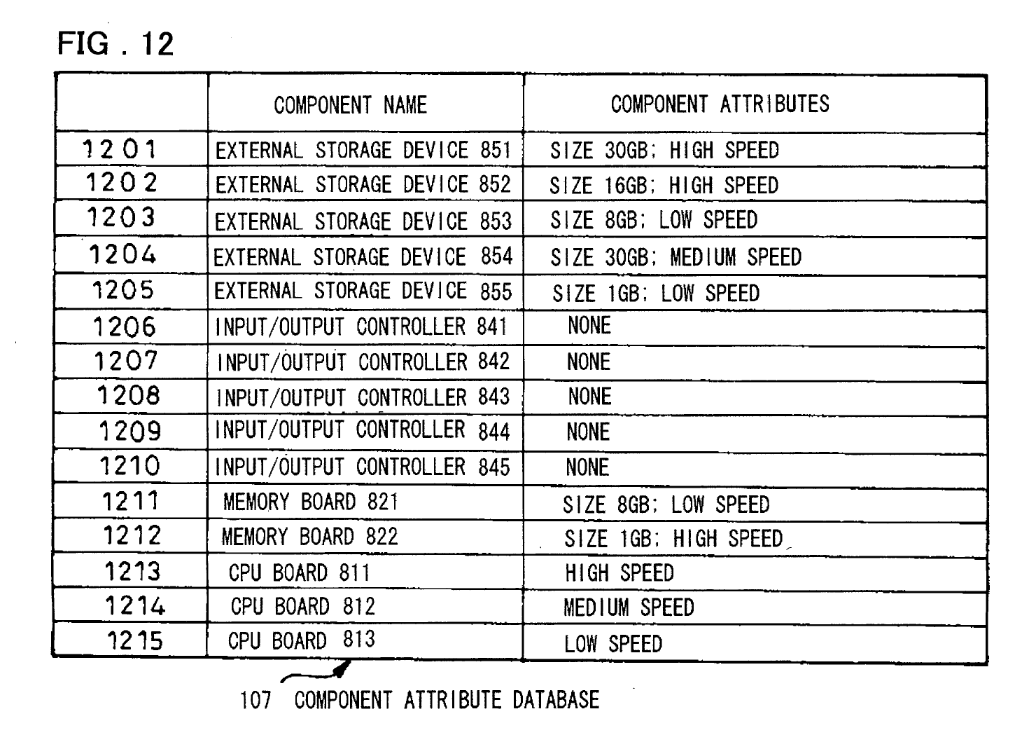

FIG. 12 shows a specified instance of the contents of the component attribute database 107 shown in FIG. 1 (an instance associated with the structure of the computer system 109 shown in FIG. 8). In each row of the component attribute database 107, there is stored the information representing ‘name of a component’ and ‘attribute of the component’. That is, this component attribute database 107 holds the information indicating the attributes of each component of the computer system 109 shown in FIG. 8.

For example, in a row 1201, it is indicated that “external storage device 851 has a storage capacity of 30 GB and the ‘speed’ indicating the performance is high”.

Referring to FIGS. 1 to 12, the operation of the system for automatically changing the computer system configuration according to the above-described embodiment is explained in detail. p Referring to the flowcharts shown in FIGS. 3 to 7, the overall operation by respective means shown in FIGS. 1 and 2 is explained.

The supervisor of the computer system 109 (configuration changing commanding personnel) gives a configuration changing command to the configuration management device 101. It is noted that, as aforesaid, the configuration changing command, which is only incomplete or partial, is allowed.

The configuration changing means 102 in the configuration management device 101 inputs the above configuration changing command to transmit it to the configuration determining means 103.

The configuration determining means 103 refers to the computer system configuration information database 104, component-to-component interdependency rule database 105, component selecting guideline database 106 and to the component attribute database 107 as necessary to determine the configuration of the computer, based on the configuration changing command, given from the preceding stage (configuration changing means 102), in a manner of complementing the configuration changing command, to decide on the computer configuration, in order to transmit the information indicating the se determined configuration (computer structure determining information) to the configuration changing device 108 (that is in order to request configuration change, such as to constitute a computer by the computer structure determining information).

The respective means in the configuration determining means 103 (see FIG. 2) execute the following processing:

On receipt of the configuration changing command from the previous stage (configuration changing means 102), the necessary component selection means 131 executes the following processing (see FIG. 3):

First, the necessary component selection means records the information acquired from the previous stage (information indicating the components represented by the configuration changing command) in the necessary component work memory 136 (step 301).

The necessary component selection means then refers to the computer system configuration information database 104 to compare the information in the computer system configuration information database 104 (information indicating the necessary minimum components for constituting a computer) to the information in the necessary component work memory 136 (information obtained from the configuration changing means 102) to list up the components which are still lacking in constituting a computer even when the components specified by the configuration changing command are used (step 302).

The information listed up at step 302 is added to the necessary component work memory 136 (step 303) to make a notification to the component selection means 132 to the effect that processing control is to be transferred (step 304). In the following, the notification to the effect that processing control is to be transferred is referred to simply as ‘notification’.

The component selection means 132, which has received the notification of step 304, executes the following processing (see FIG. 4):

First, the component selection means 132 refers to the necessary component work memory 136 to check whether or not the memory is empty (step 401).

If it is found at step 401 that ‘the necessary component work memory 136 is empty’, the component selection means makes notification to the configuration change notification means 135 (step 402). That is, the processing by the component selection means 132, guideline contemplating means 133 and the dependent component extracting means 134 is repeated until the necessary component work memory 136 is empty.

If it is found at step 401 that ‘the necessary component work memory 136 is not empty’, the component selection means selects one of the components from the necessary component work memory 136 to delete the component from the necessary component work memory 136 (step 403). The component thus selected and deleted may not only be a specified component but may also be a component type. Meanwhile, this selection is made beginning from the component concretely specified by the configuration changing command. It is noted that the sequence of selection among the components concretely specified and among those not concretely specified is arbitrary.

The component selection means 132 then refers to the computer system configuration information database 104 to list up components pertinent to the components selected at step 403 (components satisfying the condition that ‘a component is a selected component’ or ‘a component belongs to the selected component type’), from the list of the names of the components in the of a row ‘components not used as computer components’ (see row 904 of FIG. 9) (step 404).

The component selection means 132 also refers to the determined component storage memory 139 to remove (delete) the components (component names) present in the determined component storage memory 139 from the subjects listed up at step 404 (step 405).

It is then verified at this time point whether or not there are any listed-up components that are left (that is whether or not components have been found by the list-up processing up to step 405) (step 406).

If it is verified at step 406 that ‘the listed-up component(s) are left (found)’, the names of the component(s) are stored (saved) in the work memory 137 (step 407). The component selection means 132 then makes a corresponding notification to the guideline contemplating means 133 (step 408).

If on the other hand the component selection means has verified that ‘there is no listed-up component(s)’, the component selection means 132 then refers to the determined component storage memory 139 to retrieve the component(s) listed up at step 404 from the determined component storage memory 139 (step 409) to check whether or not the components listed up at step 404 are present in the determined component storage memory 139, that is whether or not the components have already become the determined components (step 410).

If it is verified at step 410 that ‘the component is present in the determined component storage memory 139’, the component selection means 132 reverts to processing at step 401 to continue the above-described processing.

If it is verified at step 410 that ‘the component is not present in the determined component storage memory 139’, it indicates that certain component(s) are lacking in the computer configuration desired by the supervisor of the computer system 109. Thus, the processing is terminated in abnormal end (step 411).

On receipt of the notification from step 408, the guideline contemplating means 133 performs the following processing (FIG. 5):

First, the guideline contemplating means 133 refers to the work memory 137, into which the preceding stage (component selection means 132 have stored the information and determines the type of the component which is to become the target of the subsequent processing (recognizes the type of the component stored in the work memory 137 as being the type of the component to be processed (step 501).

The guideline contemplating means 133 then refers to the component selecting guideline database 106 to retrieve the guideline concerning the component type determined at step 501 (step 502) to check whether or not the guideline has been detected (found) (step 503).

If it has been found at step 503 that ‘the guideline has been found’, only the component(s) consistent with the guideline are left in the work memory 137 and those not consistent with the guideline are deleted from the work memory 137 (step 504).

If it is found at step 503 that ‘guideline has not been found’, the processing at step 504 is skipped.

The guideline contemplating means 133 then at step 505 selects a suitable component(s) from the work memory 137 (the criteria of selection is optional) (step 505). The guideline contemplating means 133 then adds the component(s) (component name(s)) to the determined component storage memory 139 (step 506) and causes the component(s) to be stored in the work memory 138 (step 507) to make a notification to the dependent component extracting means 134 (step 508).

On receipt of the notification at step 508, the dependent component extracting means 134 performs the following processing (see FIG. 6):

First, the dependent component extracting means 134 refers to the component-to-component interdependency rule database 105 to retrieve the component(s) dependent on the component(s) stored in the work memory 138 (dependent components) (step 601) to check whether or not there exist the dependent component(s), that is whether or not the dependent component(s) have been found (step 602).

If it has been found at step 602 that ‘there is no dependent component(s)’, the dependent component extracting means 134 makes a corresponding notification to the component selection means 132 (step 604).

If it is determined at step 602 that ‘there exist the dependent component(s)’, the dependent component(s) are added to the work memory 136 (step 603) and subsequently a corresponding notification is made to the component selection means 132 (step 604).

On receipt of the notification of step 604, the component selection means 132 proceeds to the aforementioned processing shown in FIG. 4.

The above-described processing by the component selection means 132, guideline contemplating means 133 and the dependent component extracting means 134 is carried out repeatedly. When the necessary component work memory 136 has become empty, it is determined at step 401 that ‘the necessary component work memory 136 is empty’, such that a corresponding notification is made at step 402 to the configuration change notification means 135.

On receipt of the notification of step 402, the configuration change notification means 135 performs the following processing (see FIG. 7):

The configuration change notification means 135 first refers to the determined component storage memory 139 to request the configuration changing device 108 to construct a computer with the component(s) saved in the determined component storage memory 139 as the component(s). That is, the configuration change notification means 135 performs a configuration change request by the computer configuration determining information indicating the components stored in the determined component storage memory 139 (step 701).

It is then determined whether or not the configuration change as requested at step 701 (configuration change of the computer system 109 by the configuration-changing device 108) has met success (step 702).

If it is found at step 702 that ‘configuration change has failed’, the processing is terminated by abnormal end (step 705).

If it is found at step 702 that ‘configuration change has met success’, the information of the components, making up a newly formed computer, by the configuration change (name(s) of the component(s) in the determined component storage memory 139), is stored in (added to) the list of the names of the components in the row of ‘components used as computer components’ in the computer system configuration information database 104 (see row 903 of FIG. 9) (step 703).

The information concerning the components making up the computer (names of the components in the determined component storage memory 139) is deleted from the list of the names of the components in the row of the ‘components not used as components of the computer’ of the computer system configuration information database 104 (see row 904 of FIG. 9) (step 704).

In this manner, the configuration management device 101 determines the computer configuration by the configuration determining means 103 to transmit to transmit the so determined information (computer configuration determining information) to the configuration changing device 108 (to make a request for changing the configuration). Based on the computer configuration determining information, the configuration changing device 108 changes the configuration of the computer system 109 (constitutes a desired computer).

Second, the specified operation of the configuration determining means 103 is explained by referring to specified instances of the computer system 109, the computer system configuration information database 104, component-to-component interdependency rule database 105, component selecting guideline database 106 and the component attribute database 103, shown in FIGS. 8 to 12.

On the premises that there exist the computer system 109 shown in FIG. 8 and a set of databases having the contents shown in FIGS. 9 to 12, the specified operation in case the configuration changing means 102 has sent to the configuration determining means 103 the information indicating ‘external storage device 851’ (information specified by a command for changing the configuration to the configuration management device 101). It is noted that this information indicates that ‘the computer configuration including at least the external storage device 851 is to be determined’.

The necessary component selection means 131 in the configuration determining means 103 performs the following processing (see FIG. 3),

First, ‘external storage device 851’, which is the information obtained (received) from the previous stage (configuration changing means 102), is written in the necessary component work memory 136 (step 301).

The necessary component selection means 131 then refers to the row 901 in the computer system configuration information database 104 of FIG. 9 to recognize that ‘the lacking components are a CPU board*, a memory board*, and an input output control device*’ to list up these components (step 302).

The information specifying the types of these components (CPU board*, memory board* and the input output control device*) is added to the necessary component work memory 136 (step 303), while making a corresponding notification to the component selection means 132 (step 304).

Directly before making the notification at step 304, the necessary component work memory 136 holds the information: ‘external storage device 851, CPU board*, memory board* and the input output control device*’.

On receipt of the notification, the component selection means 132 performs the following processing (see FIG. 4).

First, the component selection means 132 refers to the necessary component work memory 136 to decipher that ‘the necessary component work memory 136 is not empty’ (step 401) to select and delete one component (including the component type) from the necessary component work memory 136 (step 403).

The components are sequentially selected by this selection processing and the processing by the component selection means 132, guideline contemplating means 133 and the dependent component extracting means 134 is repeated until the necessary component work memory 136 is empty. In the present embodiment, the five processing stages A to E shown below are repeated.

A. First Processing Stage

First, the component selection means 132 selects ‘external storage device 851’, concretely specified by the configuration changing command, and deletes it from the necessary component work memory 136.

The component selection means 132 then performs the following processing (see FIG. 4).

First, the component selection means 132 refers to the row 904 in the computer system configuration information database 104 to list up from the list of the component names of ‘components not used as computer components’ those components corresponding to the components selected at step 403, here, ‘external storage device 851’ (the component which meets the conditions) (step 404). Since ‘external storage device 851’ is entered in the row 904 of FIG. 9 in this case, this component is to be listed up.

The component selection means 132 refers to the determined component storage memory 139 (step 405) to confirm that the determined component storage memory 139 is empty and there is no ‘external storage device 851’, such that ‘external storage device 851’ is not deleted from the subject to be listed up, that is, ‘external storage device 851’ is to be listed up.

At this time point, it is checked whether or not there is any listed-up component left (step 406). Since ‘external storage device 851’ is found out in this manner, ‘external storage device 851’ is saved in the work memory 137 (step 407). Subsequently, a notification to that effect is made to the guideline contemplating means 133 (step 408).

On receipt of the notification of step 408, the guideline contemplating means 133 performs the following processing (see FIG. 5)

First, the component selection means 132 refers to the work memory 137, having stored therein ‘external storage device 851’, to determine the component type, to be targeted in the subsequent processing, as being ‘external storage device *’ (step 501).

The guideline contemplating means 133 then refers to the component selection guideline database 106 of FIG. 11 to retrieve the guideline for ‘external storage device*’ (step 502) to check whether or not there exists such guideline (step 503).

The row 1102 of FIG. 11 indicates that there is the guideline concerning ‘external storage device *’, with its contents being ‘preference is for the larger capacity value’. Since the ‘external storage device 851’ is saved in this case in the work memory 137, the component which meets the condition is only ‘external storage device 851’ if the component is selected under the guideline of ‘preference being for a larger capacity’. Thus, the information ‘external storage device 851’ is left in the work memory 137 (step 504).

Next, in the selecting processing at step 505, ‘external storage device 851’ is selected from the work memory 137. This ‘external storage device 851’ is added to the determined component storage memory 139 (step 506), while the ‘external storage device 851’ is stored in the work memory 138 (step 507), and subsequently a notification is made to the dependent component extracting means 134 (step 508).

On receipt of the notification of step 508, the dependent component extracting means 134 performs the following processing (see FIG. 6).

First, the dependent component extracting means 134 refers to the component-to-component interdependency rule database 105 to retrieve the component which is dependent on ‘external storage device 851’ which is the component saved in the work memory 138 (step 601). Here, the dependent component extracting means 134 refers to the row 1001 of FIG. 10 to extract ‘input/output controller 841’ as being a dependent component of ‘external storage device 851’.

Thus, after giving a decision that ‘there exists the dependent component’ at step 602, the dependent component (‘input/output controller 841’) is added to the necessary component work memory 136 (step 603) to make a notification to the component selection means 132 (step 604).

At this time point, the contents of the necessary component work memory 136 are ‘CPU board*, memory board*, input/output control device* and input/output controller 841’.

B. Second Processing Stage

The necessary component work memory 136 is not empty even after the processing of the component selection means 132, guideline contemplating means 133 and the dependent component extracting means 134 in the above-mentioned first processing stage. Thus, the component selection means 132 is to select and delete ‘CPU board*’ from the necessary component work memory 136 in the processing at step 403 of FIG. 4.

The component selection means 132 then lists up ‘CPU board 811’, ‘CPU board 812’ and ‘CPU board 813’ at step 404 to confirm that these are not present in the determined component storage memory 139 at steps 405 and 406 to write them in the work memory 137 at step 407.

On the other hand, the guideline contemplating means 133 refers to the component selecting guideline database 106 of FIG. 11 to confirm that there is no selection guideline concerning the CP boards (steps 502 and 503). The guideline contemplating means 133 optionally selects ‘CPU board’ from among ‘CPU board 811’, ‘CPU board 812’ and ‘CPU board 813’ (step 505) to add the ‘CPU board 811’ to the determined component storage memory 139 (step 506) as well as to write the ‘CPU board 811’ in the work memory 138 (step 507).

The dependent component extracting means 134 confirms that there is no dependent component dependent on the component in the work memory 138 (‘CPU board 811’) (steps 601 and 602) and does not carry out additional storage processing (the dependent component extracting means simply makes a notification to the component selection means 132 without doing any processing).

At this time point, the contents of the necessary component work memory 136 are ‘memory board*, input/output control device* and input/output controller 841’, while the contents of the determined component storage memory 139 are ‘external storage device 851 and CPU board 811’.

C. Third Processing Stage

The necessary component work memory 136 is not empty even after the processing by the component selection means 132, guideline contemplating means 133 and by the dependent component extracting means 134 in the above-described second processing stage. Thus, the component selection means 132 selects and deletes ‘memory board*’ from the necessary component work memory 136 in the processing at step 403 of FIG. 4.

The component selection means 132 lists up the ‘memory board 821’ and ‘memory board 822’ (step 404) and, after confirming that these components are not present in the determined component storage memory 139 (steps 405 and 406), writes these listed-up components in the work memory 137 (step 407).

On the other hand, the guideline contemplating means 133 refers to the component selecting guideline database 106 of FIG. 11 to confirm that there is present the selection guideline concerning the memory board (the guideline of ‘preference being for memory performance’ stored in the row 1101) (steps 502 and 503). The guideline contemplating means 133 refers to the component attribute database 107 of FIG. 12 to select ‘memory board 822’ which is the memory board with the highest memory performance (speed) (see rows 1211 and 1212) (steps 504 and 505) to add the ‘memory board 822’ to the determined component storage memory 139 (step 506) as well as to write the ‘memory board 822’ in the work memory 138 (step 507).

The dependent component extracting means 134 also confirms that there is no dependent component dependent on the component in the work memory 138 (‘memory board 822’) (steps 601 and 602) without performing additional storage processing (that is makes notification to the component selection means 132 without doing any processing).

At this time point, the contents of the necessary component work memory 136 are ‘input/output controller*, input/output controller 841’, while the contents of the determined component storage memory 139 are ‘external storage device 851, CPU board 811 and memory board 822’.

D. Fourth Processing Stage

The necessary component work memory 136 is not empty even after execution of the processing by the component selection means 132, guideline-contemplating means 133 and by the dependent component extracting means 134. Thus, the component selection means 132 selects and deletes ‘input/output controller*’ from the necessary component work memory 136 by the processing at step 403 of FIG. 4.

The component selection means 132 lists up ‘input/output controller 841’, ‘input/output controller 842’, ‘input/output controller 843’, ‘input/output controller 844’ and ‘input/output controller 845’ at step 404 and, after confirming that these are not present in the determined component storage memory 139 at steps 405 and 406, writes these components in the work memory 137 (step 407).

The guideline contemplating means 133 also refers to the component selecting guideline database 106 of FIG. 11 to confirm that there is no selection guideline concerning the input/output controller at steps 502 and 503 and optionally selects the ‘input/output controller 841’ from among ‘input/output controller 841’, ‘input/output controller 842’, ‘input/output controller 843’, ‘input/output controller 844’ and ‘input/output controller 845’ at step 505 to add the ‘input/output controller 841’ to the determined component storage memory 139 as well as to write the ‘input/output controller 841’ in the work memory 138 (step 507).

The dependent component extracting means 134 also refers to the component-to-component interdependency rule database 105 of FIG. 10 to confirm that the dependent component dependent on the component ‘input/output controller 841’ is the ‘external storage device 851’ at steps 601 and 602 to add (store) the ‘external storage device 851’ in the necessary component work memory 136 at step 603.

At this time point, the contents of the necessary component work memory 136 are ‘input/output controller 841 and external storage device 851’, while those of the determined component storage memory 139 are ‘external storage device 851, CPU board 811, memory board 822 and input/output controller 841’.

E. Fifth Processing Stage

The necessary component work memory 136 is not empty even after execution of the processing by the component selection means 132, guideline-contemplating means 133 and by the dependent component extracting means 134.

In the processing at step 403 of FIG. 4, the component selection means 132 selects and deletes ‘input/output controller 841’ from the necessary component work memory 136. However, since this component is already present in the determined component storage memory 139 at steps 409 and 410, control reverts to the decision step of step 401.

Since the necessary component work memory 136 is not empty, even at this time point, the component selection means 132 performs ‘selection and deletion of the next component from the necessary component work memory 136’.

That is, in the processing at step 403, the component selection means 132 selects and deletes ‘external storage device 851’ from the necessary component work memory 136. However, since this component is already present in the determined component storage memory 139 (steps 409 and 410), control is returned to the decision step 401.

At this time point, the necessary component work memory 136 becomes empty.

Since the necessary component work memory 136 is now empty, the component selection means 132 at step 402 makes a notification to the configuration change notification means 135, based on the decision of step 401.

This terminates the repetition of the processing steps of A to E above. At this time point, the contents of the determined component storage memory 139 are: ‘external storage device 851, CPU board 811, memory board 822, and input/output controller 841’.

On receipt of the notification of step 402, the configuration change notification means 135 performs the following processing (see FIG. 7).

First, the configuration change notification means 135 refers to the determined component storage memory 139 to request the configuration changing device 108 to construct a computer having a component configuration of ‘external storage device 851, CPU board 811, memory board 822, and input/output controller 841’ (step 701). Based on this configuration change request, the configuration changing device 108 constructs a computer having such component configuration in the computer system 109.

After confirming the success in the configuration change by the configuration changing device 108 (step 702), the configuration change notification means 135 causes the component information ‘external storage device 851, CPU board 811, memory board 822, input/output controller 841’ to be stored in a row of ‘components used as computer components’ (row 903) in the computer system configuration information database 104 of FIG. 9 (step 703).

Moreover, the configuration change notification means updates the information ‘component names’ in the row of ‘components not used as computer components’ (row 904) in the computer system configuration information database 104 of FIG. 9 to ‘CPU board 812, CPU board 813, memory board 821, input/output controller 842, input/output controller 843, input/output controller 844, input/output controller 845, external storage device 852, external storage device 853, external storage device 854, and external storage device 855’ (step 704).

(2) Second Embodiment

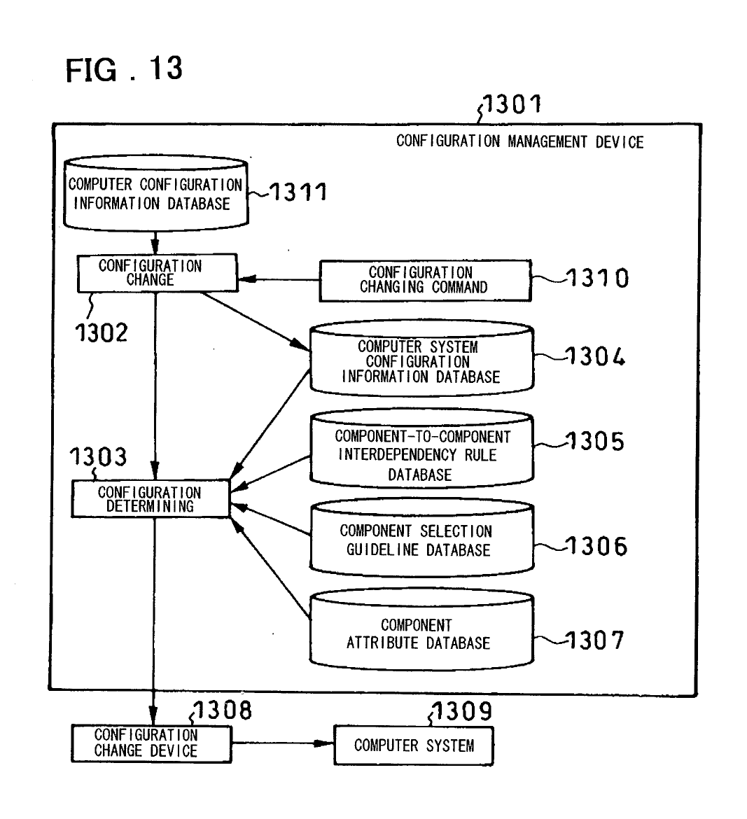

FIG. 13 is a block diagram showing the configuration of the automatic computer system configuration changing system according to a second embodiment of the present invention.

Referring to FIG. 13, the automatic computer system configuration changing system according to the present second embodiment includes a configuration management device 1301, as a device for realization of the automatic computer system configuration changing system of the present embodiment, a configuration change device 1308, capable of controlling the configuration change of the computer system 1309, and the computer system 1309, the configuration of which is to be changed.

The configuration management device 1301 is made up by configuration changing means 1302, configuration determining means 1303, a computer system configuration information database 1304, a component-to-component interdependency rule database 1305, a computer system configuration information database 1306, a component attribute database 1307, configuration changing command means 1310, and a computer system configuration information database 1311.

The constituent elements bearing the reference numerals 1301 to 1309 in the second embodiment correspond to the constituent elements bearing the reference numerals 101 to 109 in the first embodiment, and are similar to these constituent elements. That is, the present second embodiment of the automatic computer system configuration changing system corresponds to addition of the configuration changing command means 1310 and the computer system configuration information database 1311 to the automatic computer system configuration changing system of the first embodiment shown in FIG. 1.

The configuration changing command means 1310 is implemented by for example a scheduler and has the function of advising (commanding) the configuration changing means 1302 so that a desired computer will be constructed in the computer system 1309 at a desired timing based on a preset schedule information.

The computer system configuration information database 1311 is a database in which is stored the information concerning the configuration of the desired computer. That is, there is pre-stored in this database the information of the contents similar to the configuration changing command from the configuration changing command operator in the first embodiment (configuration information).

The configuration changing means 1302 in the present embodiment has the function of reading out, from the computer system configuration information database 1311, the configuration information for the computer, as specified by a command from the configuration changing command means 1310, based on this command, to notify the configuration information to the configuration determining means 1303.

It should be noted that the configuration determining means 1303 has the configuration similar to that shown in FIG. 2, and has the function similar to that of the configuration determining means 103 of the first embodiment.

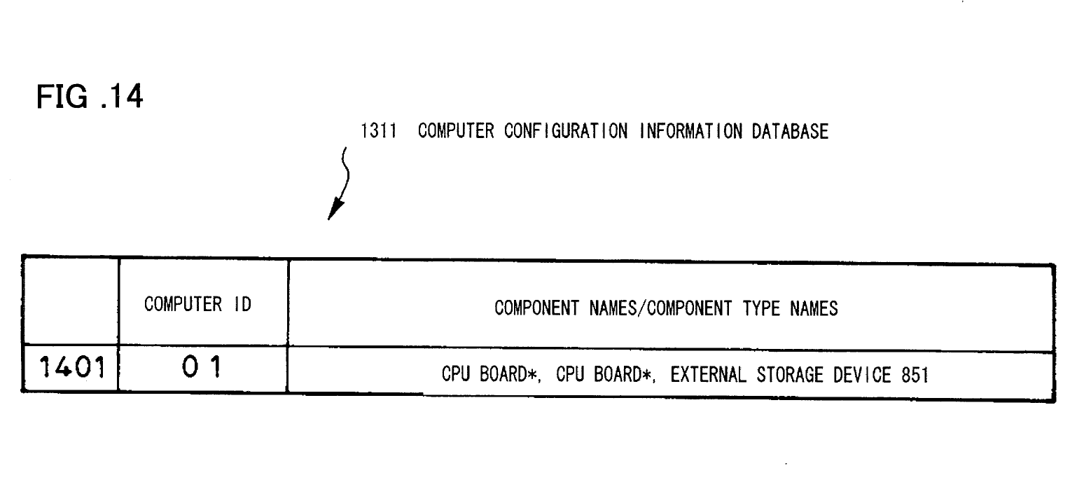

FIG. 14 shows a specified example of the contents of the computer system configuration information database 1311 shown in FIG. 13 (an example corresponding to the computer system 1309 having the same configuration as that of the computer system 109 of FIG. 8). In each row of this computer system configuration information database 1311, there is the information ‘computer ID (IDentification)’ and ‘component name/component type name’. It is noted that, although only one row is shown in FIG. 14 for simplicity of the explanation, there exist in general a plural number of rows.

For example, the configuration information of the row 1401 indicates that ‘such a computer employing at least two CPU boards and the external storage device 851 as the constituent elements (a computer having the computer ID of “01” is desirable’.

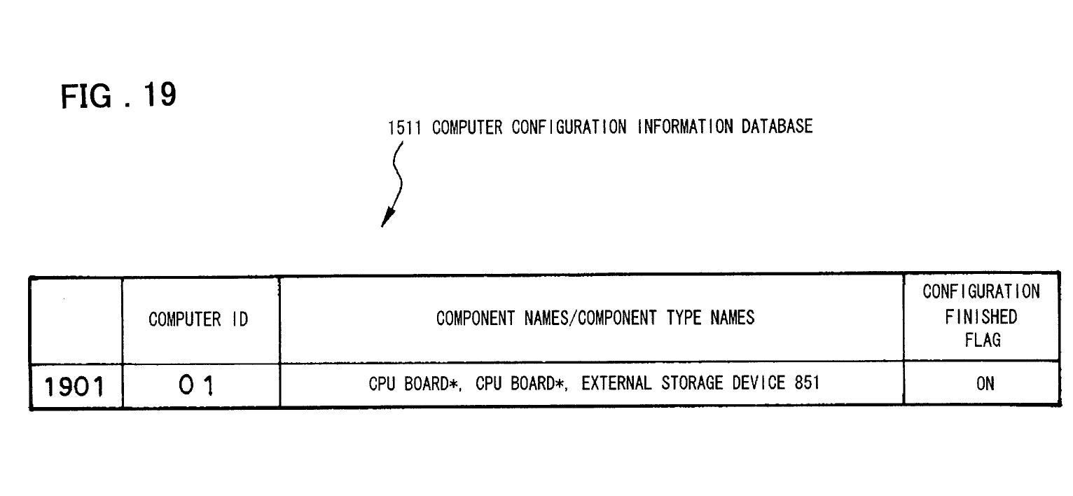

Meanwhile, in the computer system configuration information database 1311 in the present embodiment, the information ‘configuration finished flag’ may be provided in each row, as in a computer system configuration information database 1511 shown in a third embodiment to follow (see FIG. 19).

The operation of the above-described automatic computer system configuration changing system of the above-described present embodiment is now explained.

The configuration changing command means 1310 in the configuration management device 1301 supervises, for each computer to be constituted in the computer system 1309, the schedule information having the computer ID and the configuration timing (time juncture)

In constituting a computer, the configuration changing command means 1310 gives the configuration changing means 1302 a command for having the computer ID of the computer in question (command that the configuration of the computer in question is desired) based on the schedule information the configuration changing command means owns.

Based on the command, the configuration changing means 1302 reads out the configuration information of the computer specified by the computer ID designated by the command from the computer system configuration information database 1311 to make a notification of the configuration information in question to the configuration determining means 1303, in a similar manner to the notification of the configuration changing command from the configuration changing command operator in the first embodiment.

For example, if the configuration changing command means 1310 has made the above command to the configuration changing means 1302, as it designates the computer ID of “01”, the configuration changing means 1302 reads out the configuration information in a row 1401 in the computer system configuration information database 1311 of FIG. 14 to notify the configuration information to the configuration determining means 1303.

Based on this configuration information, the configuration determining means 1303 performs processing similar to that by the configuration determining means 103 of the first embodiment, as the configuration determining means 1303 handles the configuration information in the same way as the configuration changing command in the first embodiment. It is noted that the processing performed by the configuration changing device 1308 is also similar to that by the configuration changing device 108 of the first embodiment described above.

Meanwhile, a person such as a manager or supervisor of the computer system 1309, who is desirous to change the timing of constituting each computer, dynamically affords the schedule information update information to the configuration changing command means 1310 to achieve such change (command for a new configuration change).

(3) Third Embodiment

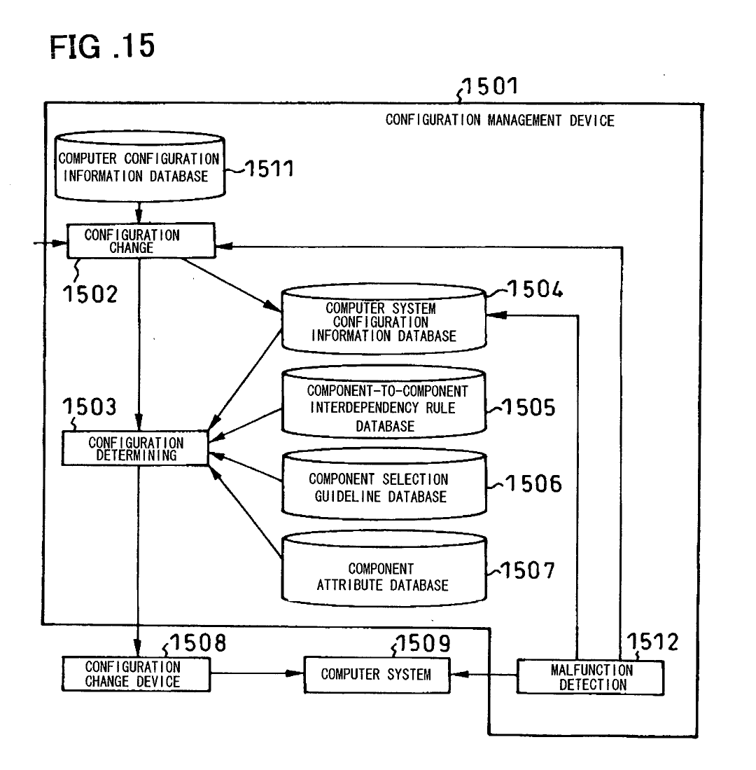

FIG. 15 is a block diagram showing the configuration of an automatic computer system configuration changing system according to a third embodiment of the present invention.

Referring to FIG. 15, the automatic computer system configuration changing system of the present embodiment includes a configuration management device 1501 for implementing the automatic computer system configuration changing system of the present embodiment, a configuration changing device 1508 allowing to control the configuration changing of the computer system 1509 and the computer system 1509 for a computer the configuration of which is to be changed.

The configuration management device 1501 is made up by configuration changing means 1502, configuration determining means 1503, a computer system configuration information database 1504, component-to-component interdependency rule database 1505, a component selection guideline database 1506, a component attribute database 1507, a computer system configuration information database 1511 and malfunction detection means 1512.

The constituent elements 1501 to 1509 of the third embodiment correspond and are similar respectively to the constituent elements 101 to 109 of the first embodiment. That is, the automatic computer system configuration changing system of the present third embodiment represents addition of the computer system configuration information database 1511 and malfunction detection means 1512 to the automatic computer system configuration changing system of the first embodiment shown in FIG. 1.

The computer system configuration information database 1511 is a database in which is stored the information concerning the configuration of a computer which is desired. The computer system configuration information database 1511 holds the configuration information indicating the contents of the configuration changing command from the configuration changing commanding personnel (configuration changing command similar to that in the first embodiment).

The malfunction detection means 1512 has the function of monitoring the computer system 1509 to detect the occurrence of malfunctions to locate the malfunctioning component and of causing the contents of the computer system configuration information database 1504 to be changed to delete the information indicating the malfunctioning component. The malfunction detection means also has the function of notifying a change of configuration of the computer system 1509, ascribable to the occurrence of the malfunction, to the configuration changing means 1502, in case of necessity, that is in case the malfunctioning component is used as a computer component on occurrence of the malfunction.

The configuration changing means 1502 of the present embodiment has the function of storing the configuration information, indicating the contents of each command for changing the configuration from the configuration changing command personnel, each time the command for changing the configuration is received, notifying each command for changing the configuration to the configuration determining means 1503, initializing the computer system configuration information database 1504, based on the command from the malfunction detection means 1512, reading out each configuration information from the computer system configuration information database 1311 and notifying the configuration information to the configuration determining means 1503.

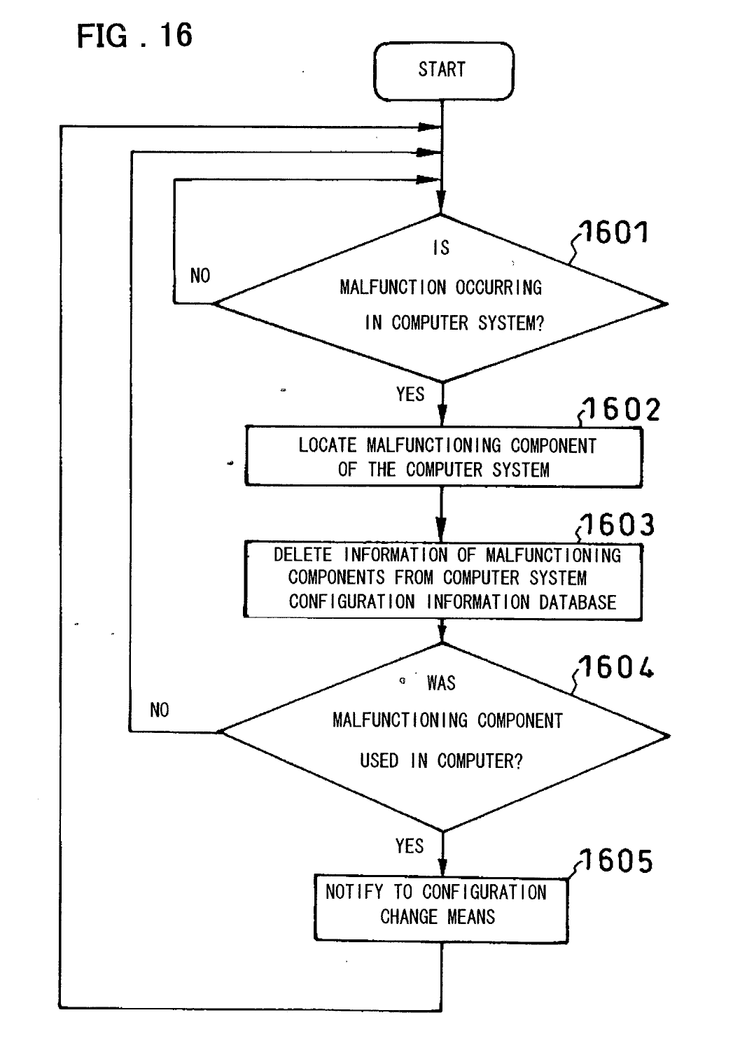

FIG. 16 is a flow diagram showing the processing by the malfunction detection means 1512. This processing is made up by a step 1601 for checking an occurrence of a computer system malfunction, a step 1602 for identifying a malfunctioning component, a step 1603 for deleting a malfunctioning component, a step 1604 for determining whether or not the computer is using a malfunctioning component and a step 1605 for making a notification to the configuration changing means 1502.

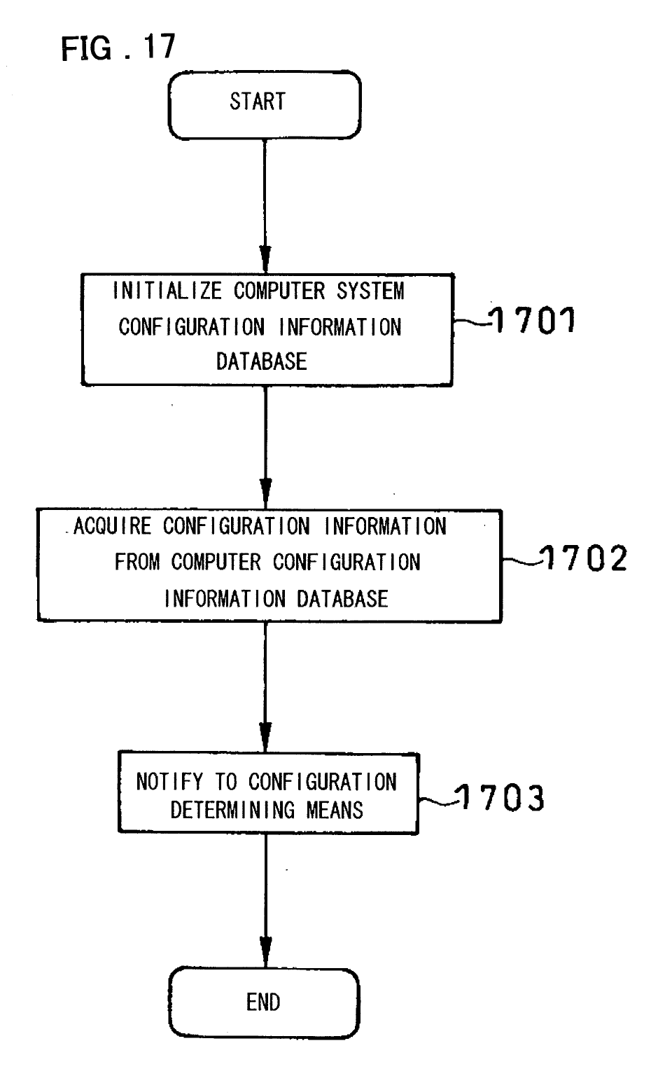

FIG. 17 is a flow diagram showing the processing by the configuration changing means 1502, premised on the presence of the computer system configuration information database 1511 and malfunction detection means 1512. This processing is made up by a step 1701 for initializing a computer system constituting information database, a step 1702 for acquiring the configuration information in the computer constituting information database, and a step 1703 for making a notification to the configuration changing means 1502.

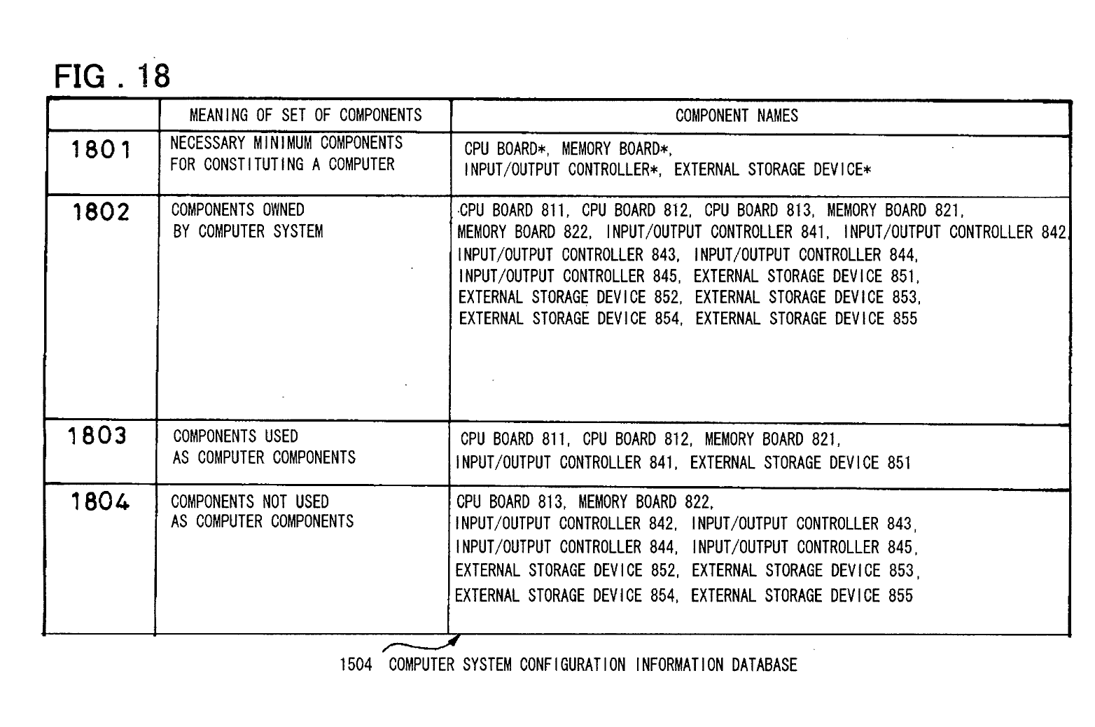

FIG. 18 shows a specified instance of the contents of the computer system configuration information database 1504 shown in FIG. 15 (an instance corresponding to the computer system 1509 having the same configuration as the configuration of the computer system 109 shown in FIG. 8). The contents of this computer system configuration information database 1504 are similar to those of the computer system configuration information database 104 of FIG. 9, but indicate the contents for a case where the information has already been stored in the row ‘components used as computer components’ (row 1803) (that is a case where a computer has already been constituted in the computer system 1509).

FIG. 19 shows a specified example of the contents of the computer system configuration information database 1511 of FIG. 15 (an example corresponding to the computer system 1509 having the same configuration as that of the computer system 109 of FIG. 8). In each row of this computer system configuration information database 1511, there are information of ‘computer ID’, ‘component name/component type name’ and ‘configuration finished flag’.

The operation of the automatic computer system configuration changing system of the above-described present embodiment is hereinafter explained.

First, the operation in case a command for changing the configuration is issued from the configuration changing commanding personnel is explained.

Each time the configuration changing means 1502 receives a configuration changing command for each computer from the configuration changing commanding personnel, the configuration changing means 1502 causes the configuration information, indicating the contents of the configuration changing command, to be stored in a column ‘component name/component type name’ in each row of the computer system configuration information database 1511, while causing the computer ID of the computer, corresponding to the configuration information, to be stored in a column ‘computer ID’ in each row.

Similarly to the configuration changing means 102 of the first embodiment, the configuration changing means 1502 imparts the command for changing the configuration to the configuration determining means 1503.

Based on this configuration changing command, the configuration determining means 1503 performs an operation similar to the operation of the configuration determining means 103 of the first embodiment. (It is noted that the configuration changing device 1508 also performs an operation similar to that of the configuration changing device 108 of the first embodiment, based on the configuration changing command from the configuration determining means 1503).

If the computer configuration by the configuration changing device 1508 has led to success, the configuration changing means 1502 sets the information (ON) indicating the success in the configuration on a ‘configuration finished flag’ for the computer in question of the computer system configuration information database 1511.

Second, the operation in case malfunction has occurred in the computer system 1509 is explained.

Here, the concrete operation is explained using the computer system configuration information database 1504 of FIG. 18 and the computer system configuration information database 1511 of FIG. 19. It is assumed that the computer system 1509 is similar in configuration to the computer system 109 of FIG. 8, and that the contents of the component-to-component interdependency rule database 1505, component selection guideline database 1506 and the component attribute database 1507 are similar to those of the respective databases of FIGS. 10 to 12 (showing the contents used as specified examples of the respective databases in the first embodiment).

It is also assumed that, in the computer system 1509, only a computer constituted by the CPU boards 811 and 812, memory board 821, input/output controller 841 and the external storage device 851 (computer having the computer ID of “01”) is used, as shown in row 1803 in the computer system configuration information database 1504 of FIG. 18. It is now assumed that, in this state, the CPU board 812 has fallen into disorder.

In this case, the malfunction detection means performs the following processing (see FIG. 16).

First, the malfunction detection means 1512 is monitoring the computer system 1509 at all times, to check whether or not any malfunction is occurring in the computer system 1509 (whether or not any malfunction has been detected) (step 1601).

If it is found at step S1601 that ‘a malfunction has occurred’, it is determined which component is malfunctioning (decision on the malfunctioning component) (step 1602).

Since the malfunctioning component is unusable as a computer component, the information concerning the malfunctioning component, as detected at step 1602, is deleted from the computer system configuration information database 1504 (step 1603).

In the present embodiment, it is the CPU board 812 that is malfunctioning. Since there is the information ‘CPU board 812’ present in rows 1802 and 1803 in FIG. 18, this information is deleted.

It is then checked whether or not the malfunctioning component has been used as a computer component (step 1604). In the present embodiment, it is checked whether or not the information concerning the malfunctioning component was present in (the row of ‘component used as computer component’) was present in advance of the selection step 1603 in the row 1803 in the computer system configuration information database 1504 of FIG. 18.

If it is found at step 1604 that ‘malfunctioning component was not being used as the computer component’, the malfunction detection means 1512 reverts to the decision step 1601 (leading end of the flowchart of the processing by the malfunction detection means 1512) to begin the monitoring of the computer system 1509.

On the other hand, if it is found at step 1604 that ‘malfunctioning component was being used as the computer component’, the malfunction detection means makes a notification to the configuration changing means 1502 (commands the configuration change of the computer system 1509 chargeable to the malfunction (step 1605). The malfunction detection means then reverts to the decision step 1601 to again begin the monitoring of the computer system 1509.

In the present embodiment, since there is ‘CPU board 812’, as the malfunctioning component, in the row 1803 of FIG. 18, it is seen that the malfunctioning component was used as the component. So, a notification is made to the configuration changing means 1502 to command configuration change of the computer system 1509 and subsequently the malfunction detection means begins to monitor the computer system 1509.

On receipt of the notification of step 1605, the configuration changing means 1502 performs the following processing (see FIG. 17).

First, the configuration changing means 1502 initializes the computer system configuration information database 1504 (step 1701).

It should be noted that ‘initializing the computer system configuration information database 1504’ refers to setting the information of the computer system configuration information database 1504 in such a manner as to indicate that there is no component being used as the computer component. Taking the computer system configuration information database 1504 of FIG. 18 as an example, such initialization refers to deleting the component information of the row 1803 (row of the ‘component used as computer component’) to indicate that there is no component being used in a computer, and also refers to copying the entire component information of row 1802 (row of ‘components owned by the computer’) to the row 1804 (row of ‘components not used as computer component’) to indicate that there is no component used as computer components. However, since the information concerning the ‘CPU board 812’ as the malfunctioning component has been deleted by the malfunction detection means 1512, there is no information concerning this component (malfunctioning component) neither in the row 1802 nor in the row 1804.

After the initialization at step 1701, the configuration information in which the information indicating the completion of configuration (ON) is set in the ‘configuration completion flag’ in the computer system configuration information database 1511, here the configuration information of row 1901 in FIG. 19, is acquired (step 1702).

Meanwhile, the configuration information shown in row 1901 of FIG. 19, similarly to that in the row 1401 of FIG. 14, refers to the contents that ‘a desired computer is such a one employing at least two CPU boards and the external storage device 851 as components’.

Finally, the configuration information is notified to the configuration determining means 1503 (step 1703).

Based on this configuration information, the configuration determining means 1503 finds the configuration of the computer corresponding to the configuration information (the computer configuration determining information indicating the ultimate configuration contents) to notify the computer configuration determining information to the configuration changing device 1508.

This sequence of operations is similar to the sequence of operations where there is made a command for changing the configuration from a configuration changing command personnel, that is to the sequence of operations of the configuration determining means 103 in the first embodiment. Meanwhile, should there be plural configuration information, each computer is constructed on the basis of each configuration information, and each computer configuration determining information is notified to the configuration-changing device 1508.

In the present embodiment, the configuration determining means 1503 determines the computer configuration of ‘CPU board 811, CPU board 813, memory board 821, input/output controller 841 and the external storage device 851 (it being noted that the CPU board 812, as a malfunctioning component, is naturally not employed)’ from the configuration information, obtained from the configuration changing means 1502, to notify the computer configuration determining information to the configuration changing device 1508.

Based on the computer configuration determining information, obtained from the configuration determining means 1503, the configuration changing device 1508 changes the computer configuration of the computer system 1509.

If there is any computer which has met failure in configuration, the ‘configuration completed flag’ for the computer in the computer system configuration information database 1511 is updated to the information indicating that the ‘configuration completed flag’ in the computer system configuration information database 1511 for the computer in question is unfinished.

In the present embodiment, described above, in which the computer system configuration information database 1511 and the malfunction detection means 1512 are combined, and in which the computer configuration is specified not by the concrete component names, but by the component type names, it is possible to remove the malfunctioning component automatically, should malfunction occur in the component specified by the component type, and to use other operation-feasible components (other components belonging to the same component type) to re-constitute the computer automatically.

Moreover, since the human operation such as an operation by the configuration changing command personnel is not required in the re-constituting processing, it becomes possible to reduce the time during which the computer remains unusable, thereby improving the efficiency in use of the computer in the computer system 1509.

(4) Fourth Embodiment

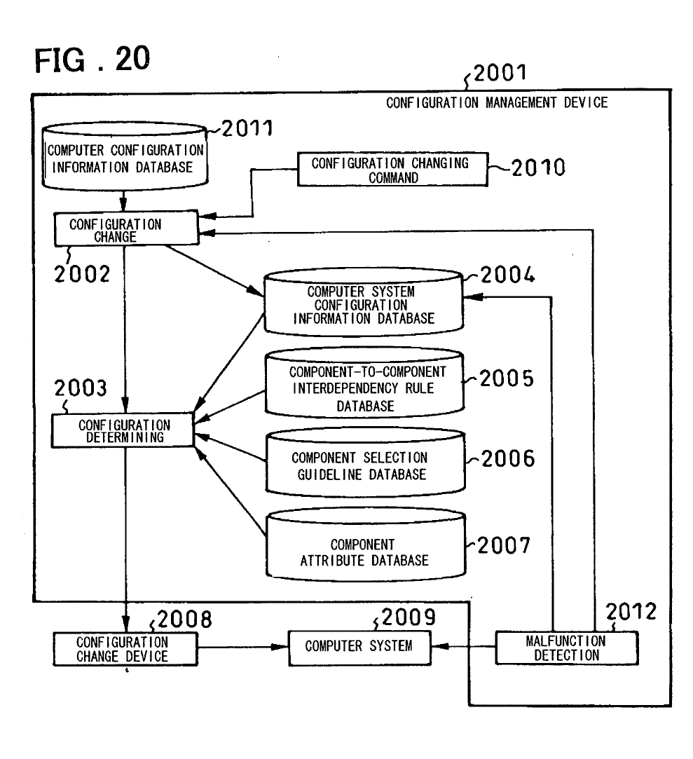

FIG. 20 is a block diagram showing the configuration of the automatic computer system configuration changing system according to a fourth embodiment of the present invention.

Referring to FIG. 20, the automatic computer system configuration changing system of the present embodiment is made up by a configuration management device 2001, as a device for implementing the automatic computer system configuration changing system of the present embodiment, a configuration change device 2008, capable of controlling the change of configuration of a computer system 2009, and the computer system 2009 the configuration of which is to be changed.

The configuration management device 2001 is made up by configuration changing means 2002, configuration determining means 2003, a computer system configuration information database 2004, component-to-component interdependency rule database 2005, a component selection guideline database 2006, a component attribute database 2007, configuration changing command means 2010, computer system configuration information database 2011 and malfunction detection means 2012.

It should be noted that the constituent elements having reference numerals of 2001 to 2009 in this fourth embodiment correspond and are similar to the constituent elements having reference numerals of 101 to 109 of the first embodiment. The configuration changing command means 2010 is similar to the configuration changing command means 1310 of the second embodiment described above. Moreover, the computer system configuration information database 2011 and malfunction detection means 2012 are similar to the computer system configuration information database 1511 and malfunction detection means 1512 in the fourth embodiment, respectively. However, at least one configuration information is set in advance in the computer system configuration information database 2011, as in the computer system configuration information database 1311.

As for the operation of the automatic computer system configuration changing system of the present embodiment, the operation in changing the configuration of the computer system 2009 under a command by the configuration changing command means 2010 is similar to that of the second embodiment, while the operation in changing the configuration of the computer system 2009 under the command of the malfunction detection means 2012 is similar to that in the third embodiment. However, if, in changing the configuration of the computer system 2009 under the command of the configuration changing command means 2010, the computer configuration has met success, the setting of the information indicating the configuration completion (ON) is made in the ‘configuration completion flag’ in the configuration information for the computer in question in the computer system configuration information database 2011, as in the case of changing the configuration of the computer system 1509 which is based on a command for changing the configuration from a configuration changing command personnel in the third embodiment.

(5) Modification and Extension of the Second, Third and Fourth Embodiments

In the automatic computer system configuration changing system of the second embodiment, described above, the configuration information in the computer system configuration information database 1311 includes ‘computer ID’ and ‘component name/component type name’ (more specifically the information corresponding thereto (see FIG. 14). On the other hand, in the automatic computer system configuration changing system of the third and fourth embodiments, the configuration information in the computer system configuration information databases 1511/2011 includes ‘computer ID’, ‘component name/component type name’ and ‘configuration finished flag’ (more specifically the information corresponding thereto (see FIG. 19).

Moreover, it is presupposed that, as a principle, each configuration information is the information for constituting a computer.

It should be noted that the computer system, the configuration of which is to be changed in accordance with the present invention, is not limited to the computer system shown in FIG. 8, but may be thought of as a computer system comprised of C pieces of CPU boards, M pieces of memory boards, I pieces of input/output controllers and S pieces of external storage devices, where C, M, I and S denote integers of fairly large numerical values. Since plural external storage devices can be connected to a sole input/output controller, I and S are not necessary of the same numerical value.

In this computer system, these components may be freely combined together to constitute plural computers of the same configuration.

In order to cope with such change in the configuration in a computer system, such configuration of adding the information ‘required number’ (the information indicating the number of the computers of the same configuration) in each configuration information in the computer system configuration information database 1311/1511/2011 may be thought of as the modification of the automatic computer system configuration changing system of the above-described second to fourth embodiments.

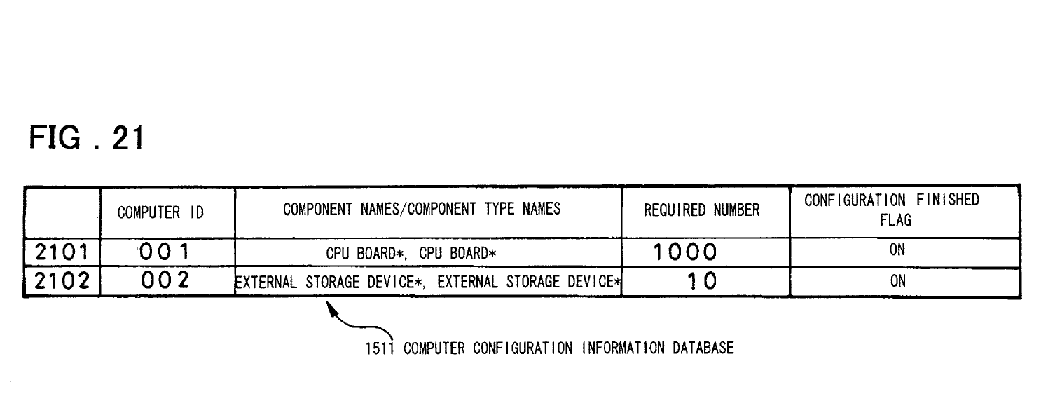

For example, there is added, in each row of the computer system configuration information database 1511 in the modification of the automatic computer system configuration changing system of the above-described third embodiment, the information ‘required number’, along with ‘computer ID’, ‘computer name/component type name’ and ‘configuration completion flag’, as shown in FIG. 21.

As for the constituent elements, other than those described above, the above modification is of the same structure and operation as those of the second to fourth embodiments described above.

The present modification to the automatic computer system configuration changing system according to the third embodiment is now explained in detail.

FIG. 21 shows specified contents of the computer system configuration information database 1511 to which has been added the ‘required number’. That is, in this computer system configuration information database 1511, a column ‘required number’ is newly provided in the computer system configuration information database 1511 of FIG. 19.

The configuration information in each row in the computer system configuration information database 1511 in this modification means that “there are requested a number indicated in the ‘required number’ of the computers indicated by the ‘component name/component type name’, that is the computers identified by the ‘computer ID’”.

The respective rows in FIG. 21 specifically are as indicated in (a) and (b) below.

(a). The configuration information of row 2101 requests 1000 computers each constituted to have at least two CPU boards.

(b). The configuration information of row 2102 requests 10 computers each constituted to have at least two external storage devices.

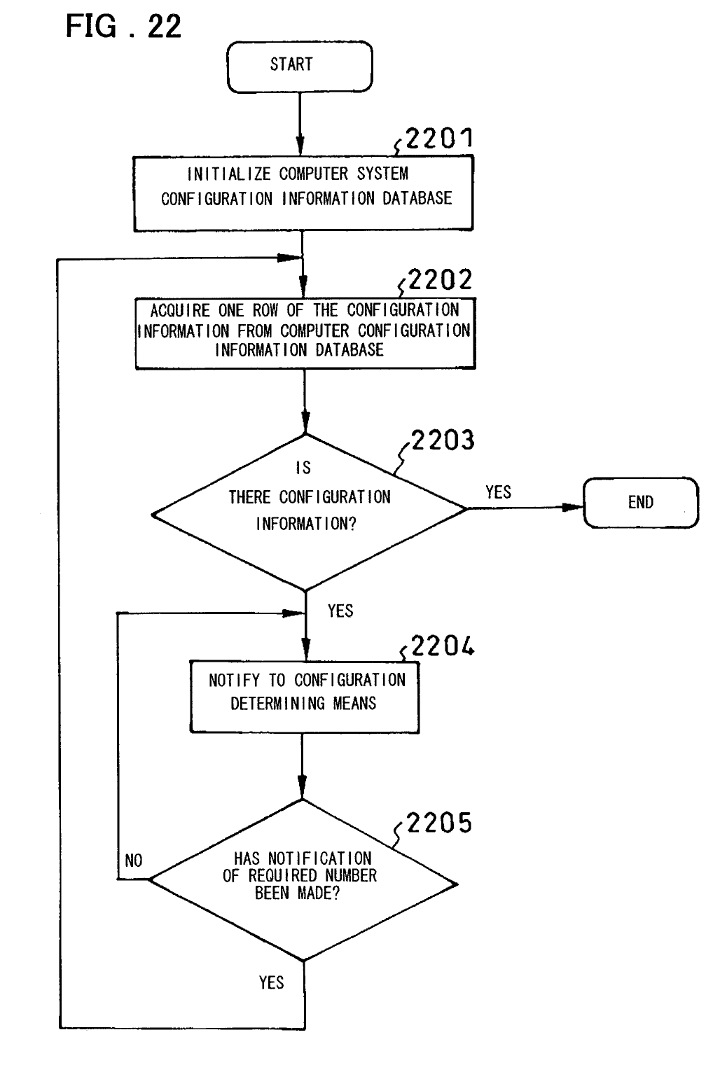

FIG. 22 is a flow diagram for illustrating the processing by the configuration changing means 1502 in the present embodiment (the processing by the configuration changing means 1502 premised on the presence of the computer system configuration information database 1511 and the malfunction detection means 1512). This processing is comprised of a step 2201 for initializing the computer system configuration information database, a step 2202 for acquiring a row of the configuration information in the computer system configuration information database, a step 2203 for verifying the presence of the configuration information, a step 2204 for giving a notification to the configuration changing means 1502, and a step 2205 for verifying the end of the notification of the required number.

In this modification, the configuration changing means 1502 on receipt of the notification from the malfunction detection means 1512 (command for changing the configuration of the computer system 1509 chargeable to a malfunction) performs the following processing (see FIG. 22). It is noted that the computer system 1509, the configuration of which is to be changed, is assumed to be the ‘computer system comprised of C pieces of CPU boards, M pieces of memory boards, I pieces of input/output controllers and S pieces of external storage devices’, as described above.

First, the computer system configuration information database 1504 is initialized (step 2201).

In the present embodiment, the information corresponding to the component names of the C pieces of CPU boards, M pieces of memory boards, I pieces of input/output controllers and S pieces of external storage devices, from which the component names of the malfunctioning components have been deleted, is stored by this initializing processing in the row of the ‘components owned by the computer system’ in the computer system configuration information database 1504. On the other hand, nothing is stored in the row ‘components used as computer components’, while the contents which are the same as the contents of the ‘components owned by the computer system’ are stored in the row components not used as computer components

Then, the configuration information in the computer system configuration information database 1511 (see FIG. 21) having the ‘required number’ added thereto (the configuration information comprised of the ‘configuration finished flag’ and the information indicating the finished configuration set therein), is read out by one row (step 2202) to check whether or not there persists or is left the configuration information that can be read in (step 2203). If it is found that ‘there is left no configuration information’, that is if the totality of the configuration information of the subject of processing has been completely read in, the processing is terminated.

If it is verified at step 2203 that ‘there persists the configuration information’, the required number of the so acquired configuration information is notified to the configuration determining means 1503 (steps 2204 and 2205) to cause the configuration changing device 1508 to constitute the desired computers on the computer system 1509 via configuration determining means 1503.

Thus, in the present embodiment, in order to constitute plural computers of the same configuration, the ‘required number’ in each configuration information of the computer system configuration information database 1511 is checked. It is then verified at step 2205 whether or not the ‘required number’ of the same configuration information has been notified. This enables the required number of the same configuration information to be notified to the configuration changing means 1502 at step 2204 to constitute the desired computers.

If it is verified at step 2205 that the ‘required number’ of the configuration information in question has been notified, the processing reverts to step 2202 to read in the configuration information of another computer from the computer system configuration information database 1511 to continue the processing similar to that described above to implement the configuration of the desired computers. It should be noted that repetition of the processing similar to that described above enables plural computers of different sorts to be produced.

When the computer system, the configuration of which is to be changed, is of an extremely large scale, it may be premeditated to be feasible to constitute thousands and tens of thousands of computers. In such case, the configuration information is required in the computer system configuration information databases 1311/1511/2011 for the configuration of the totality of the computers of the same configuration, in the above-described second to fourth embodiments, with the consequence that the labor involved in making commands for the configuration of the respective computers is prohibitively increased in proportion to the size of the scale of the computer system.

In the present embodiment, the volume of the information to be afforded for constituting a computer(s) is appreciably smaller, as may be seen from an example given in FIG. 21, so that the information volume is not increased in proportion to the scale of the computer system.

That is, by applying the present embodiment, it is possible to save the labor involved in giving a command on the computer configuration (command for changing the computer system configuration).

(6) Fifth Embodiment

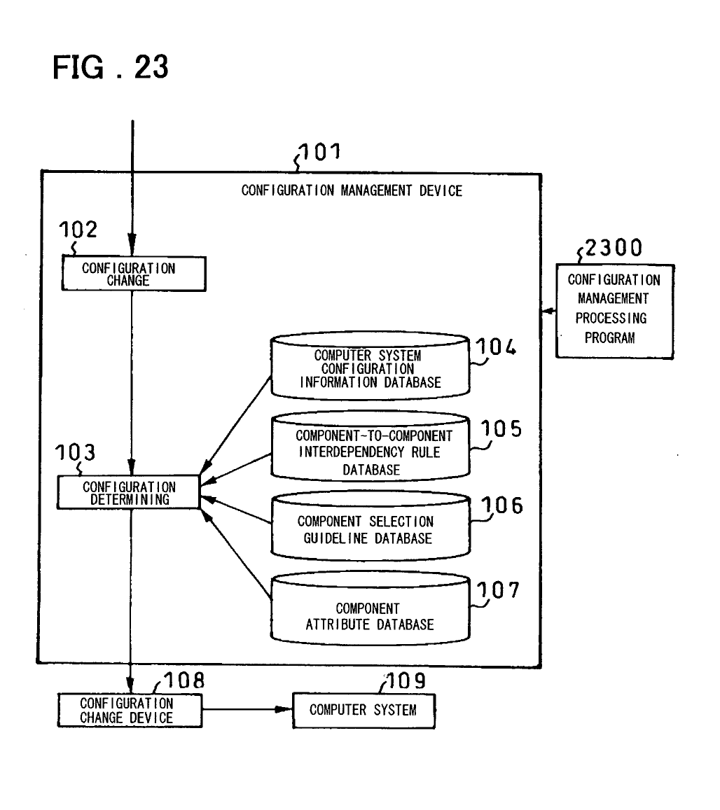

FIG. 23 is a block diagram showing the configuration of the automatic computer system configuration changing system according to a fifth embodiment of the present invention.

Referring to FIG. 23, the automatic computer system configuration changing system according to the fifth embodiment of the present invention differs from that of the first embodiment shown in FIG. 1 as to provision of a configuration management processing program 2300.

The configuration management processing program 2300 is read-in by the configuration management device 101, comprised of the computer system configuration information database 104, component-to-component interdependency rule database 105, component selecting guideline database 106 and the component attribute database 107, to control the operation of the configuration management device 101 as the configuration changing means 102 and the configuration determining means 103 (the necessary component selection means 131, component selection means 132, guideline contemplating means 133, dependent component extracting means 134 and the configuration change notification means 135 (see FIG. 2)). The operation of the configuration management device 101 (operation of the configuration changing means 102 and the configuration determining means 103) under control by the configuration management processing program 2300 is identified with the operation of the configuration management device 101 (the operation of the configuration changing means 102 and the configuration determining means 103) of the first embodiment and hence the detailed explanation therefor is omitted for simplicity.

(7) Sixth Embodiment

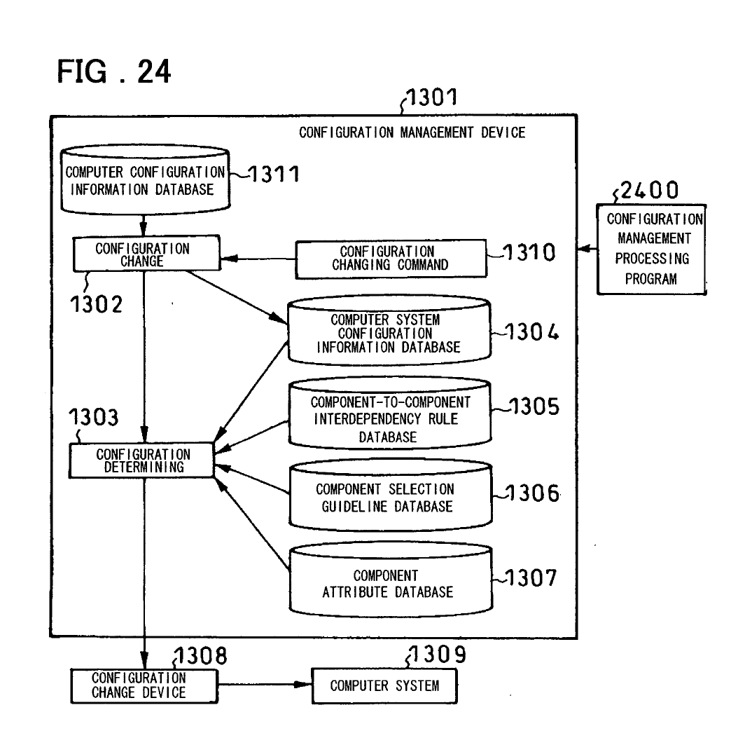

FIG. 24 is a block diagram showing the configuration of an automatic computer system configuration changing system according to a sixth embodiment of the present invention.

Referring to FIG. 24, the automatic computer system configuration changing system according to the sixth embodiment of the present invention differs from that according to the second embodiment of the present invention, shown in FIG. 13, as to provision of a configuration management processing program 2400.

The configuration management processing program 2400 is read-in by the configuration management device 1301, comprised of the computer system configuration information database 1304, component-to-component interdependency rule database 1305, component selecting guideline database 1306, component attribute database 1307 and the computer system configuration information database 13 11, to control the operation of the configuration management device 1301 as the configuration changing means 1302, configuration determining means 1303 and the configuration changing command means 1310. The operation of the configuration management device 1301 (operation of the configuration changing means 1302 configuration determining means 1303 and the configuration changing command means 1310) under control by the configuration management processing program 2400 is identified with the operation of the configuration management device 1301 (the operation of the configuration changing means 1302, configuration determining means 1303 and the configuration changing command means 1310) of the second embodiment and hence the detailed explanation therefor is omitted for simplicity.

(8) Seventh Embodiment

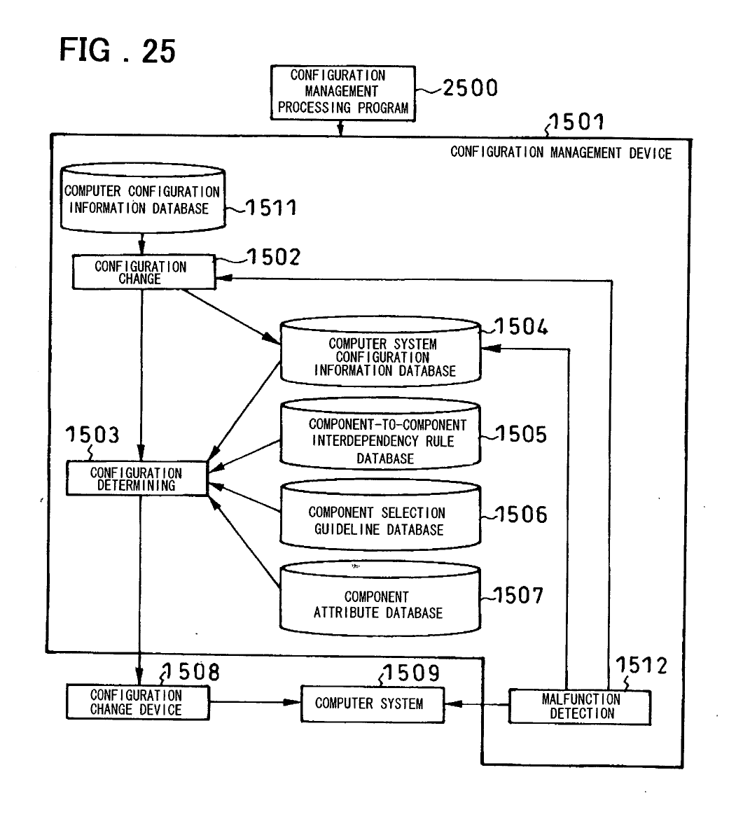

FIG. 25 is a block diagram showing the configuration of an automatic computer system configuration changing system configuration management device according to a sixth embodiment of the present invention.

Referring to FIG. 25, the automatic computer system configuration changing system according to the seventh embodiment of the present invention differs from that according to the third embodiment of the present invention, shown in FIG. 15, as to provision of a configuration management processing program 2500.

The configuration management processing program 2500 is read-in by the configuration management device 1501, comprised of the computer system configuration information database 1504, component-to-component interdependency rule database 1505, component selecting guideline database 1506, the component attribute database 1507, and the computer system configuration information database 1511, to control the operation of the configuration management device 1501 as the configuration changing means 1502, the configuration determining means 1503 and the malfunction detection means 1512. The operation of the configuration management device 1501 (operation of the configuration changing means 1502, configuration determining means 1503 and the malfunction detection means 1512) under control by the configuration management processing program 2500 is identified with the operation of the configuration management device 1501 (the operation of the configuration changing means 1502, configuration determining means 1503 and the and the malfunction detection means 1512) of the third embodiment and hence the detailed explanation therefor is omitted for simplicity.

(9) Eighth Embodiment

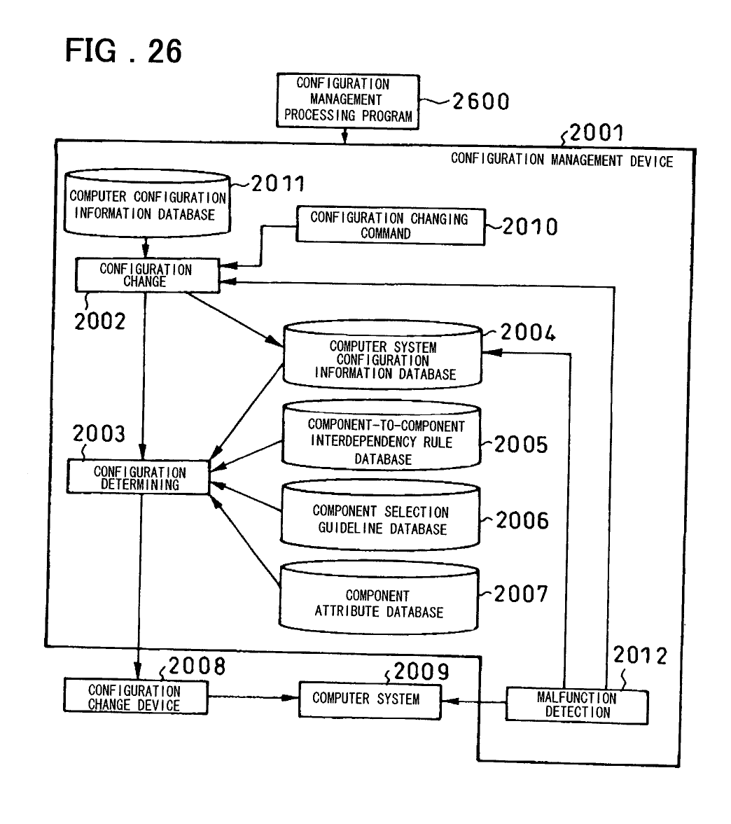

FIG. 26 is a block diagram showing the configuration of an automatic computer system configuration changing system configuration management device according to a eighth embodiment of the present invention.

Referring to FIG. 26, the automatic computer system configuration changing system according to the eighth embodiment of the present invention differs from that according to the fourth embodiment of the present invention, shown in FIG. 20, as to provision of a configuration management processing program 2600.

The configuration management processing program 2600 is read-in by the configuration management device 2001, comprised of the computer system configuration information database 2004, component-to-component interdependency rule database 2005, component selecting guideline database 2006, component attribute database 2007 and the computer system configuration information database 2011, to control the operation of the configuration management device 2001 as the configuration changing means 2002, configuration determining means 2003, configuration changing command means 2010 and the malfunction detection means 2012. The operation of the configuration management device 2001 (operation of the configuration changing means 2002, configuration determining means 2003, configuration changing command means 2010 and the malfunction detection means 2012) under control by the configuration management processing program 2600 is identified with the operation of the configuration management device 2001 (the operation of the configuration changing means 2002, configuration determining means 2003, configuration changing command means 2010 and the malfunction detection means 2012) of the fourth embodiment and hence the detailed explanation therefor is omitted for simplicity.

(10) Modification and Extension of Sixth, Seventh and Eighth Embodiments

The automatic computer system configuration changing system according to the sixth, seventh and eighth embodiments may be thought of as the modification in which the ‘required number’ is added to the configuration information in the computer system configuration information databases 1311/1511/2011, as in the modifications of the second, third and fourth embodiments, discussed in the section (5) above.

The meritorious effects of the present invention are summarized as follows.

The present invention, described above, gives the following meritorious effects:

The first meritorious effect is that, by the function proper to the computer system configuration information database and the configuration determining means (mainly the component selection means), the number of the component information that must be afforded in changing the computer system configuration can be decreased to curtail the labor involved in giving instructions as to the component information. This enables a system manager not well versed in changing the computer system configuration to change the computer system configuration extremely easily. (This holds true for the following second and third meritorious effects.

The second meritorious effect is that, by the function proper to the component selection guideline database, component attribute database and the configuration determining means (mainly the guideline contemplating means), it becomes unnecessary to give the information for physically specifying the components, as the component information for implementing changes in the computer system configuration, so that it becomes possible to determine the computer system flexibly and automatically (to readily and automatically construct the flexible computer system configuration) in dependence upon the components usable in changing the configuration).

The third meritorious effect is that, by multifariously changing the contents of the component selection guideline database and the component attribute database, the configuration of a computer system having various features can be determined.

The fourth meritorious effect is that, by judiciously combining the malfunction detection means, it becomes possible to improve the flexibility in use of the computers in the computer system. Specifically, the input timing to the configuration changing means may be matched to the timing of the occurrence of the malfunction in the computer system to cause the configuration determining means to determine substitution components for the malfunctioning components to realize automatic restoration of the computer system to improve the flexibility in using the computer.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A system for automatically changing a computer system configuration, comprising: a configuration management device; a configuration changing device; and a computer system, the configuration of which is to be changed,
said configuration management device, which makes a request for changing a configuration of the computer system to said configuration changing device that is a device for enabling the computer system configuration to be changed, comprising:
configuration changing means for receiving a configuration changing command, in which incomplete/partial contents is allowed, from an operator responsible for changing the configuration of the computer system, and for delivering configuration information represented by the configuration changing command to said configuration determining means; and
said configuration determining means referring to a computer system configuration information database and to a component-to-component interdependency rule database to complement the incomplete/partial configuration information received from said configuration changing means, said configuration determining means also referring to a component selection guideline database and to a component attribute database to cope properly and flexibly with a selection guideline to build up a computer system, said configuration determining means resultantly finding the computer configuration determining information to notify the configuration changing device of the computer configuration determining information.

2. A system for automatically changing a computer system configuration, comprising: a configuration management device; a configuration changing device; and a computer system, the configuration of which is to be changed,
said configuration management device, which makes a request for changing a configuration of the computer system to said configuration changing device that is a device for enabling the computer system configuration to be changed, comprising:
configuration changing commanding means for giving a command to configuration changing means to construct a desired computer in a computer system, the configuration of which is to be changed, at a desired timing, based on preset scheduling information;
a computer system configuration information database, as a database having stored information concerning the configuration of the desired computer, said database having stored in advance one or more of configuration information including the contents of a configuration changing command, in which incomplete/partial contents is allowed, from an operator responsible for changing the configuration of the computer system;
said configuration changing means for reading out, from said computer system configuration information database, the configuration information for a computer specified by a command from said configuration changing command means, based on said command, and for notifying said configuration information to configuration determining means; and
said configuration determining means for referring to said computer system configuration information database and to a component-to-component interdependency rule database to complement the incomplete/partial configuration information received from the configuration changing means, said configuration determining means also referring to a component selection guideline database and to a component attribute database to cope properly flexibly with a selection guideline to build up a computer system, said configuration determining means resultantly finding the computer configuration determining information to notify the configuration changing device of the computer configuration determining information.

3. A system for automatically changing a computer system configuration, comprising: a configuration management device; a configuration changing device; and a computer system, the configuration of which is to be changed,
said configuration management device, which makes a request for changing the configuration of the computer system to said configuration changing device that is a device for enabling the computer system configuration to be changed, comprising:
a computer system configuration information database having stored information concerning a configuration of a desired computer, said computer system configuration information database having stored, as the configuration information, information indicating contents of a configuration changing command from an operator responsible for changing the configuration of the computer system, said information also indicating whether or not a computer pertinent to said command for changing the configuration has already been constituted;
malfunction detection means for monitoring the computer system, the configuration of which is to be changed, detecting an occurrence of a malfunction, locating a malfunctioning component, and for changing the contents of said computer system configuration information database in such a manner as to delete the information indicating said malfunctioning component; said malfunction detection means sending a command for changing the configuration of the computer system as a result of occurrence of a malfunction in case the malfunctioning component is being used as a computer component in case of the malfunction occurrence;
said configuration changing means for causing, on receipt of each configuration changing command, in which incomplete/partial contents is allowed, from the operator responsible for changing the configuration, the configuration information indicating the contents of each configuration changing command to be stored in said computer system configuration information database, said configuration changing means subsequently notifying the configuration determining means of each configuration information, said configuration changing means initializing said computer system configuration information database based on a command from said malfunction detection means and reading out from said computer system configuration information database the configuration information having set therein the information indicating that the computer system has already been constituted, said configuration changing means then notifying said configuration determining means of said configuration information; and
said configuration determining means for referring to said computer system configuration information database and to a component-to-component interdependency rule database to complement the incomplete/partial configuration information received from the configuration changing means, said configuration determining means also referring to a component selection guideline database and to a component attribute database to cope properly flexibly with a selection guideline to build up a computer system, said configuration determining means resultantly finding the computer configuration determining information to notify the configuration changing device of the computer configuration determining information.

4. A system for automatically changing a computer system configuration, comprising: a configuration management device; a configuration changing device; and a computer system, the configuration of which is to be changed,
said configuration management device, which makes a request for changing the configuration of the computer system to said configuration changing device that is a device for enabling the computer system configuration to be changed, comprising:
configuration changing command means for giving a command to configuration changing means in order to constitute a desired computer in a computer system, the configuration of which is to be changed, at a desired timing, based on preset schedule information:
a computer system configuration information database, as a database having stored information concerning the configuration of a desired computer, said database having stored in advance one or more of the configuration information including the contents of configuration changing command, in which incomplete/partial contents is allowed, from an operator taking charge of changing the configuration;
malfunction detection means for monitoring a computer system, the configuration of which is to be changed, detecting an occurrence of a malfunction, locating a malfunctioning component, and for changing the contents of the computer system configuration information database in such a manner as to delete the information indicating said malfunctioning component;
said malfunction detection means sending to configuration changing means a command for changing the configuration of the computer system, as a result of occurrence of a malfunction, in case the malfunctioning component is being used as a computer component in case of the malfunction occurrence;
said configuration changing means reading out, based on a command from said configuration changing command means, the configuration information for a computer system, specified by said command, from said computer system configuration information database, said configuration changing means, notifying said configuration information to configuration determining means, initializing said computer system configuration information database, based on a command from said malfunction detection means, and reading out from the computer system configuration information database the information indicating that the computer has already been constituted, to notify said configuration determining means of said configuration information; and
said configuration determining means referring to said computer system configuration information database and to a component-to-component interdependency rule database to complement the incomplete/partial configuration information received from the configuration changing means, said configuration determining means also referring to a component selection guideline database and to a component attribute database to cope properly flexibly with a selection guideline to build up a computer system, said configuration determining means resultantly finding the computer configuration determining information to notify the configuration changing device of the computer configuration determining information.

5. The system as defined in claim 2, wherein in said computer system configuration information database, the information of a required number is added in each configuration information, and wherein
said configuration changing means is adapted to refer to the required number in said computer system configuration information database to notify said configuration determining means of said required number of the computer configuration information of the same configuration.

6. The system as defined in claim 1, wherein said configuration determining means include:
necessary component selection means for referring to said computer system configuration information database, for complementing a component that is to be added to the components as specified by the configuration information received from said configuration changing means, in order to constitute the computer, and for storing the complemented configuration information on a required component work memory;
component selection means for selecting the components one by one from the required component work memory, having the information stored therein by said necessary component selection means, and for deleting the so selected components, until said required component work memory becomes empty, said component selection means referring to said computer system configuration information database to list up one or plurality of components which are the selected components corresponding to the components not used as computer components and the information of which is not present in a determined component storage memory;
guideline contemplating means for referring to a component selection guideline database for retrieving the guideline for the component type of one or plurality of components listed up by said component selection means and for adding to said determined component storage memory the information of one or plurality of components selected from the components consistent with such guideline which has been found;
dependent component extraction means for referring to a component-to-component interdependency rule database to retrieve components dependent on the components as selected by said guideline contemplating means and for adding to said necessary component work memory the information of said dependent components if there are such dependent components; and
configuration change notification means for requesting a configuration changing device to constitute a computer system having as constituent components the components the information of which has been stored in said determined component storage memory in case said component selection means has found that the required component work memory is empty, said configuration change notification means verifying whether or not the requested configuration change has met success to update said computer system configuration information database based on the verification result.

7. A computer program product for causing a configuration management device, which makes a request for changing the configuration of a computer system to a configuration changing device, that is a device enabling the computer system configuration to be changed, to operate as configuration changing means for receiving a configuration changing command, in which incomplete/partial contents is allowed, from an operator responsible for changing the configuration, and for delivering configuration information represented by the configuration changing command to configuration determining means; and as said configuration determining means;
wherein said configuration determining means referring to a computer system configuration information database and to a component-to-component interdependency rule database, complements the incomplete/partial configuration information received from the configuration changing means,
said configuration determining means, also referring to a component selection guideline database and to a component attribute database, copes properly flexibly with a selection guideline to build up a computer system; and
said configuration determining means resultantly finds the computer configuration determining information to notify the configuration changing device of said computer configuration determining information.

8. A computer program product for causing a configuration management device, which makes a request for changing the configuration of a computer system to a configuration changing device, that is a device enabling the computer system configuration to be changed, said configuration management device including a computer system configuration information database, as a database having stored the information concerning the configuration of the desired computer, said database having stored in advance one or more of the configuration information of the same contents as the contents of a configuration changing command from the operator taking charge of changing the configuration to operate as configuration changing commanding means for giving a command to configuration changing means to construct a desired computer in a computer system, the configuration of which is to be changed, at a desired timing, based on preset scheduling information;
as configuration changing means for reading out, from said computer system configuration information database, the configuration information for a computer specified by said command, and for notifying said configuration information to configuration determining means; and
as said configuration determining means for referring to a computer system configuration information database and to a component-to-component interdependency rule database to complement the incomplete/partial configuration information received from the configuration changing means, said configuration determining means also referring to a component selection guideline database and to a component attribute database to deal properly and flexibly with a selection guideline to build up a computer system,
said configuration determining means resultantly finding the computer configuration determining information to notify the computer configuration determining information to said configuration changing device.

9. A computer program product for causing a configuration management device, which makes a request for changing the configuration of a computer system to a configuration changing device, that is a device enabling the computer system configuration to be changed, said configuration management device including a computer system configuration information database, as a database having stored therein the information concerning the configuration of a desired computer, said computer system configuration information database holding the configuration information indicating the contents of a configuration changing command from an operator responsible for changing the configuration, said configuration information also indicating whether or not a computer corresponding to said command for changing the configuration has already been constituted, to operate
as malfunction detection means for monitoring a computer system, the configuration of which is to be changed, detecting an occurrence of a malfunction, locating a malfunctioning component, and changing the contents of said computer system configuration information database in such a manner as to delete the information indicating said malfunctioning component; said malfunction detection means sending a command for changing the configuration of the computer system chargeable to occurrence of a malfunction in case the malfunctioning component is being used as a computer component in case of the malfunction occurrence;
as said configuration changing means for causing the configuration information indicating the contents of each configuration changing command to be stored in said computer system configuration information database each time each configuration changing command, allowing for incomplete/partial contents, is received from an operator responsible for changing the configuration, and for notifying each configuration information to configuration determining means; said configuration changing means initializing said computer system configuration information database based on a command from said malfunction detection means, reading out from said computer system configuration information database the configuration information having set therein the information indicating that the computer has already been constituted, and notifying said configuration determining means of said configuration information; and
as said configuration determining means for referring to said computer system configuration information database and to a component-to-component interdependency rule database to complement the incomplete/partial configuration information received from the configuration changing means, said configuration determining means also referring to a component selection guideline database or to a component attribute database to cope properly flexibly with a selection guideline to build up a computer system; said configuration determining means resultantly finding the computer configuration determining information to notify the configuration changing device of the computer configuration determining information.

10. A computer program product for causing a configuration management device, which makes a request for changing the configuration of a computer system to a configuration changing device, that is a device enabling the computer system configuration to be changed, said configuration management device including a computer system configuration information database, as a database having stored therein the information concerning the configuration of a desired computer, said computer system configuration information database holding in advance at least one configuration information indicating whether or not the computer has already been constituted, to operate
as configuration changing command means for giving a command to configuration changing means in order to constitute a desired computer in a computer system, the configuration of which is to be changed, at a desired timing, based on he preset schedule information:
as malfunction detection means for monitoring a computer system, the configuration of which is to be changed, for detecting an occurrence of a malfunction, for locating a malfunctioning component, and for changing the contents of said computer system configuration information database in such a manner as to delete the information indicating said malfunctioning component; said malfunction detection means sending a command for changing the configuration of the computer system as a result of occurrence of a malfunction in case the malfunctioning component is being used as a computer component in case of the malfunction occurrence;
as said configuration changing means reading out, based on a command from said configuration changing command means, the configuration information for a computer, specified by said command, from said computer system configuration information database, and notifying said configuration information to said configuration determining means; said configuration changing means initializing said computer system configuration information database based on a command from said malfunction detection means, and reading out from said computer system configuration information database the configuration information having set therein the information indicating that the computer has already been constituted, to notify said configuration determining means of said configuration information;
and as said configuration determining means referring to said computer system configuration information database and to a component-to-component interdependency rule database to complement or render perfect the incomplete/partial configuration information received from the configuration changing means, said configuration determining means also referring to a component selection guideline database or to a component attribute database to deal properly and flexibly with a selection guideline to build up a computer system; said configuration determining means resultantly finding the computer configuration determining information to notify the configuration changing device of the computer configuration determining information.

11. The system as defined in claim 3, wherein in said computer system configuration information database, the information of a required number is added in each configuration information, and wherein
said configuration changing means is adapted to refer to the required number in said computer system configuration information database to notify said configuration determining means of said required number of the computer configuration information of the same configuration.

12. The system as defined in claim 4, wherein in said computer system configuration information database, the information of a required number is added in each configuration information, and wherein
said configuration changing means is adapted to refer to the required number in said computer system configuration information database to notify said configuration determining means of said required number of the computer configuration information of the same configuration.

13. The system as defined in claim 2, wherein the configuration determining means include:
necessary component selection means for referring to said computer system configuration information database, for complementing components that are to be added to the components as specified by the configuration information received from said configuration changing means, in order to constitute the computer, and for storing the complemented configuration information on a required component work memory;
component selection means for selecting the components one by one from the required component work memory, having the information stored therein by said necessary component selection means, and for deleting the so selected components, until said required component work memory is empty, said component selection means referring to the computer system configuration information database to list up one or plural components which are the selected components corresponding to the components not used as computer components and the information of which is not present in a determined component storage memory;
guideline contemplating means for referring to a component selection guideline database for retrieving the guideline for the component type of the components listed up by said component selection means and for adding to a determined component storage memory the information of components selected from the components consistent with such guideline which has been found;
dependent component extraction means for referring to a component-to-component interdependency rule database to retrieve components dependent on the components as selected by said guideline contemplating means and for adding to said necessary component work memory the information of said dependent components if there are such dependent components; and
configuration change notification means for requesting a configuration changing device to constitute a computer having as constituent components the components the information of which has been stored in said determined component storage memory in case said component selection means has found that the required component work memory is empty, said configuration change notification means verifying whether or not the requested configuration change has met success to update the computer system configuration information database based on the verification result.

14. The system as defined in claim 3, wherein the configuration determining means include:
necessary component selection means for referring to said computer system configuration information database, for complementing components that are to be added to the components as specified by the configuration information received from said configuration changing means, in order to constitute the computer, and for storing the complemented configuration information on a required component work memory;
component selection means for selecting the components one by one from the required component work memory, having the information stored therein by said necessary component selection means, and for deleting the so selected components, until said required component work memory is empty, said component selection means referring to the computer system configuration information database to list up only those components which are the selected components corresponding to the components not used as computer components and the information of which is not present in a determined component storage memory;
guideline contemplating means for referring to a component selection guideline database for retrieving the guideline for the component type of the components listed up by said component selection means and for adding to a determined component storage memory the information of components selected from the components consistent with such guideline which has been found;
dependent component extraction means for referring to a component-to-component interdependency rule database to retrieve components dependent on the components as selected by said guideline contemplating means and for adding to said necessary component work memory the information of said dependent components if there are such dependent components; and
configuration change notification means for requesting a configuration changing device to constitute a computer having as constituent components the components the information of which has been stored in said determined component storage memory in case said component selection means has found that the required component work memory is empty, said configuration change notification means verifying whether or not the requested configuration change has met success to update the computer system configuration information database based on the verification result.

15. The system as defined in claim 4, wherein the configuration determining means include:
necessary component selection means for referring to said computer system configuration information database, for complementing components that are to be added to the components as specified by the configuration information received from said configuration changing means, in order to constitute the computer, and for storing the complemented configuration information on a required component work memory;
component selection means for selecting the components one by one from the required component work memory, having the information stored therein by said necessary component selection means, and for deleting the so selected components, until said required component work memory is empty, said component selection means referring to the computer system configuration information database to list up only those components which are the selected components corresponding to the components not used as computer components and the information of which is not present in a determined component storage memory;
guideline contemplating means for referring to a component selection guideline database for retrieving the guideline for the component type of the components listed up by said component selection means and for adding to a determined component storage memory the information of components selected from the components consistent with such guideline which has been found;
dependent component extraction means for referring to a component-to-component interdependency rule database to retrieve components dependent on the components as selected by said guideline contemplating means and for adding to said necessary component work memory the information of said dependent components if there are such dependent components; and
configuration change notification means for requesting a configuration changing device to constitute a computer having as constituent components the components the information of which has been stored in said determined component storage memory in case said component selection means has found that the required component work memory is empty, said configuration change notification means verifying whether or not the requested configuration change has met success to update the computer system configuration information database based on the verification result.
